(19) United States
(12) Patent Application Publication
(10) Pub. No.: US 2018/0110000 A1
(43) Pub. Date: Apr. 19, 2018

(54) WAKE-UP RECEIVER SCHEDULING

(71) Applicant: QUALCOMM Incorporated, San Diego, CA (US)

(72) Inventors: Stephen Jay SHELLHAMMER, Ramona, CA (US); Santosh Paul ABRAHAM, San Diego, CA (US); Linhai HE, San Diego, CA (US); Bin TIAN, San Diego, CA (US); Yanjun SUN, San Diego, CA (US); George CHERIAN, San Diego, CA (US); Abhishek Pramod PATIL, San Diego, CA (US); Alfred ASTERJADHI, San Diego, CA (US); Yan ZHOU, San Diego, CA (US)

(21) Appl. No.: 15/667,517

(22) Filed: Aug. 2, 2017

Related U.S. Application Data
(60) Provisional application No. 62/410,286, filed on Oct. 19, 2016.
(60) Provisional application No. 62/458,995, filed on Feb. 14, 2017.

(51) Int. Cl. H04W 52/02; H04W 56/00; H04W 84/12; H04W 88/08

(52) U.S. Cl. CPC H04W 52/0206; H04W 88/08; H04W 84/12; H04W 56/0015

(57) ABSTRACT

A station configured to operate in a wireless network includes low-power protocol circuitry configured to operate according to a low-power protocol coupled to primary protocol circuitry configured to operate according to a first protocol. The low-power protocol circuitry includes a wake-up receiver configured to transition into a receive mode according to a medium access schedule. The wake-up receiver is also configured to receive synchronization signals from a wake-up transmitter of an access point in the wireless network. Each synchronization signal is received according to a slot-skipping transmit schedule of the wake-up transmitter. The low-power protocol circuitry also includes a low-power processor configured to synchronize a clock of the wake-up receiver to a clock of the wake-up transmitter based on at least one of the synchronization signals.

### I. CROSS-REFERENCE TO RELATED APPLICATIONS

The present application claims priority from U.S. Provisional Patent Application No. 62/410,286, filed Oct. 19, 2016 and entitled “WAKE-UP RECEIVER SCHEDULING” and U.S. Provisional Patent Application No. 62/458,995, filed Feb. 14, 2017 and entitled “WAKE-UP RECEIVER SCHEDULING”, the contents of which are expressly incorporated herein by reference in their entirety.

### II. FIELD

The present disclosure is generally related to scheduling schemes for a wake-up receiver.

### III. DESCRIPTION OF RELATED ART

Stations (e.g., wireless telephones) in a wireless network may operate in two power modes. For example, a station in an Institute of Electrical and Electronics Engineers (IEEE) 802.11 (e.g., “Wi-Fi”) wireless network may operate in an “awake” mode (e.g., a fully powered mode of operation) and in a “sleep” mode. During operation in the awake mode, the station may be able to transmit data to (and receive data from) an access point in the IEEE 802.11 wireless network. During operation in the sleep mode, the radio frequency capabilities of the station may be significantly reduced to conserve power and the station may not able to transmit data to (or receive data from) the access point.

### IV. SUMMARY

According to one example of the techniques disclosed herein, a station configured to operate in a wireless network includes low-power protocol circuitry configured to operate according to a low-power protocol coupled to primary protocol circuitry configured to operate according to a first protocol. The low-power protocol circuitry includes a wake-up receiver configured to transition into a receive mode according to a medium access schedule. The wake-up receiver is also configured to receive synchronization signals from a wake-up transmitter of an access point in the wireless network. Each synchronization signal is received according to a slot-skipping transmit schedule of the wake-up transmitter. The low-power protocol circuitry also includes a low-power processor configured to synchronize a clock of the wake-up receiver to a clock of the wake-up transmitter based on at least one of the synchronization signals.

According to another example of the techniques disclosed herein, a method of operating a station in a wireless network includes transitioning a wake-up receiver into a receive mode according to a medium access schedule. The station includes primary protocol circuitry operating according to a first protocol and low-power protocol circuitry operating according to a low-power protocol. The wake-up receiver is included in the low-power protocol circuitry. The method also includes receiving, at the wake-up receiver, synchronization signals from a wake-up transmitter of an access point in the wireless network. Each synchronization signal is received according to a slot-skipping transmit schedule of the wake-up transmitter. The method also includes synchronizing a clock of the wake-up receiver to a clock of the wake-up transmitter based on at least one of the synchronization signals.

According to another example of the techniques disclosed herein, a non-transitory computer-readable medium includes instructions for operating a station in a wireless network. The instructions, when executed by a processor within the station, cause the processor to perform operations including transitioning a wake-up receiver into a receive mode according to a medium access schedule. The station includes primary protocol circuitry operating according to a first protocol and low-power protocol circuitry operating according to a low-power protocol. The wake-up receiver is included in the low-power protocol circuitry. The operations also include receiving, at the wake-up receiver, synchronization signals from a wake-up transmitter of an access point in the wireless network. Each synchronization signal is received according to a slot-skipping transmit schedule of the wake-up transmitter. The operations also include synchronizing a clock of the wake-up receiver to a clock of the wake-up transmitter based on at least one of the synchronization signals.

According to another example of the techniques disclosed herein, a station configured to operate in a wireless network includes means for operating according to a low-power protocol coupled to means for operating according to a first protocol. The means for operating according to the low-power protocol includes means for transitioning into a receive mode according to a medium access schedule and for receiving synchronization signals from a wake-up transmitter of an access point in the wireless network. Each synchronization signal is received according to a slot-skipping transmit schedule of the wake-up transmitter. The means for operating according to the low-power protocol also include means for synchronizing a clock of the means for transitioning to a clock of the wake-up transmitter based on at least one of the synchronization signals.

According to another example of the techniques disclosed herein, an access point configured to operate in a wireless network includes low-power protocol circuitry configured to operate according to a low-power protocol coupled to primary protocol circuitry configured to operate according to a first protocol. The low-power circuitry includes a wake-up transmitter configured to determine a medium access schedule of a wake-up receiver of a station in the wireless network. The medium access schedule indicates time periods when the wake-up receiver is in a receive mode. The wake-up transmitter is also configured to transmit synchronization signals to the wake-up receiver according to a slot-skipping transmit schedule. The slot-skipping transmit schedule is based at least in part on the medium access schedule.

According to another example of the techniques disclosed herein, a method of operating an access point in a wireless network includes determining, at a low-power processor, a medium access schedule of a wake-up receiver of a station in the wireless network. The medium access schedule indicates time periods when the wake-up receiver is in a receive mode. The access point includes low-power circuitry operating according to a low-power protocol and primary protocol circuitry operating according to a first protocol. The low-power circuitry includes the low-power processor and a wake-up transmitter. The method also includes transmitting, at the wake-up transmitter, synchronization signals to the wake-up receiver according to a slot-skipping transmit schedule. The slot-skipping transmit schedule is based at least in part on the medium access schedule.

According to another example of the techniques disclosed herein, a non-transitory computer-readable medium includes instructions for operating an access point in a wireless network. The instructions, when executed by a processor within the access point, cause the processor to perform operations including determining, at a low-power processor, a medium access schedule of a wake-up receiver of a station in the wireless network. The medium access schedule indicates time periods when the wake-up receiver is in a receive mode. The access point includes low-power circuitry operating according to a low-power protocol and primary protocol circuitry operating according to a first protocol. The low-power circuitry includes the low-power processor and a wake-up transmitter. The operations also include transmitting, at the wake-up transmitter, synchronization signals to the wake-up receiver according to a slot-skipping transmit schedule. The slot-skipping transmit schedule is based at least in part on the medium access schedule.

According to another example of the techniques disclosed herein, an access point configured to operate in a wireless network includes means for operating according to a low-power protocol coupled to means for operating according to a first protocol. The means for operating according to the low-power protocol includes means for determining a medium access schedule of a wake-up receiver of a station in the wireless network. The medium access schedule indicates time periods when the wake-up receiver is in a receive mode. The means for operating according to the low-power protocol also includes means for transmitting synchronization signals to the wake-up receiver according to a slot-skipping transmit schedule. The slot-skipping transmit schedule is based at least in part on the medium access schedule.

According to another example of the techniques disclosed herein, a station configured to operate in a wireless network includes low-power protocol circuity configured to operate according to a low-power protocol coupled to primary protocol circuitry configured to operate according to a first protocol. The low-power protocol circuitry includes a wake-up receiver configured to periodically transition into a receive mode according to a particular interval. The wake-up receiver is also configured to receive synchronization signals from a wake-up transmitter of an access point in the wireless network. Each synchronization signal is received at a particular integer multiple of the particular interval. The particular integer multiple is greater than one. The low-power protocol circuitry also includes a low-power processor configured to synchronize a clock of the wake-up receiver to a clock of the wake-up transmitter based on at least one of the synchronization signals.

According to another example of the techniques disclosed herein, a method of operating a station in a wireless network includes periodically transitioning a wake-up receiver into a receive mode according to a particular interval. The station includes primary protocol circuitry operating according to a first protocol and low-power protocol circuitry operating according to a low-power protocol. The wake-up receiver is included in the low-power protocol circuitry. The method also includes receiving, at the wake-up receiver, synchronization signals from a wake-up transmitter of an access point in the wireless network. Each synchronization signal is received at a particular integer multiple of the particular interval. The particular integer multiple is greater than one. The method further includes synchronizing a clock of the wake-up receiver to a clock of the wake-up transmitter based on at least one of the synchronization signals.

According to another example of the techniques disclosed herein, a non-transitory computer-readable medium includes instructions for operating a station in a wireless network. The instructions, when executed by a processor within the station, cause the processor to perform operations including periodically transitioning a wake-up receiver into a receive mode according to a particular interval. The station includes primary protocol circuitry operating according to a first protocol and low-power protocol circuitry operating according to a low-power protocol. The wake-up receiver is included in the low-power protocol circuitry. The operations also include receiving, at the wake-up receiver, synchronization signals from a wake-up transmitter of an access point in the wireless network. Each synchronization signal is received at a particular integer multiple of the particular interval. The particular integer multiple is greater than one. The operations also include synchronizing a clock of the wake-up receiver to a clock of the wake-up transmitter based on at least one of the synchronization signals.

According to another example of the techniques disclosed herein, a station configured to operate in a wireless network includes means for operating according to a low-power protocol coupled to means for operating according to a first protocol. The means for operating according to the low-power protocol includes means for periodically transitioning into a receive mode according to a particular interval and for receiving synchronization signals from a wake-up transmitter of an access point in the wireless network. Each synchronization signal is received at a particular integer multiple of the particular interval. The particular integer multiple is greater than one. The means for operating according to the low-power protocol also includes means for synchronizing a clock of the wake-up receiver to a clock of the wake-up transmitter based on at least one of the synchronization signals.

According to another example of the techniques disclosed herein, an access point configured to operate in a wireless network includes low-power protocol circuitry configured to operate according to a low-power protocol coupled to primary protocol circuitry configured to operate according to a first protocol. The low-power protocol circuitry includes a wake-up transmitter configured to determine a particular interval that a wake-up receiver of a station in the wireless network periodically transitions into a receive mode. The wake-up transmitter is further configured to transmit synchronization signals to the wake-up receiver at a particular integer multiple of the particular interval. The particular integer multiple is greater than one.

According to another example of the techniques disclosed herein, a method of operating an access point in a wireless network includes determining, at a low-power processor, a particular interval that a wake-up receiver of a station in the wireless network periodically transitions into a receive mode. The access point includes low-power circuitry operating according to a low-power protocol and primary protocol circuity operating according to a first protocol. The low-power circuitry includes the low-power processor and a wake-up transmitter. The method also includes transmitting, at the wake-up transmitter, synchronization signals to the wake-up receiver at a particular integer multiple of the particular interval. The particular integer multiple is greater than one.

According to another example of the techniques disclosed herein, a non-transitory computer-readable medium includes instruction for operating an access point in a wireless network. The instructions, when executed by a processor within the access point, cause the processor to perform operations including determining, at a low-power processor, a particular interval that a wake-up receiver of a station in the wireless network periodically transitions into a receive mode. The access point includes low-power circuitry operating according to a low-power protocol and primary protocol circuity operating according to a first protocol. The low-power circuitry includes the low-power processor and a wake-up transmitter. The operations also include transmitting, at the wake-up transmitter, synchronization signals to the wake-up receiver at a particular integer multiple of the particular interval. The particular integer multiple is greater than one.

According to another example of the techniques disclosed herein, an access point configured to operate in a wireless network includes means for operating according to a low-power protocol coupled to means for operating according to a first protocol. The means for operating according to the low-power protocol includes means for determining a particular interval that a wake-up receiver of a station in the wireless network periodically transitions into a receive mode and for transmitting synchronization signals to the wake-up receiver at a particular integer multiple of the particular interval. The particular integer multiple is greater than one.

According to another example of the techniques disclosed herein, a station configure to operate in a wireless network includes low-power protocol circuity configured to operate according to a low-power protocol coupled to primary protocol circuitry configured to operate according to a first protocol. The low-power protocol circuitry includes a wake-up receiver configured to periodically transition into a receive mode according to a particular interval. The wake-up receiver is also configured to receive synchronization signals from a wake-up transmitter of an access point in the wireless network. Each synchronization signal is received within a particular time period of a last received synchronization signal. The particular integer multiple is greater than one. The low-power protocol circuitry also includes a low-power processor configured to synchronize a clock of the wake-up receiver to a clock of the wake-up transmitter based on at least one of the synchronization signals.

According to another example of the techniques disclosed herein, a method of operating a station in a wireless network include periodically transitioning a wake-up receiver into a receive mode according to a particular interval. The station includes primary protocol circuitry operating according to a first protocol and low-power protocol circuitry operating according to a low-power protocol. The wake-up receiver is included in the low-power protocol circuitry. The method also includes receiving, at the wake-up receiver, synchronization signals from a wake-up transmitter of an access point in the wireless network. Each synchronization signal is received within a particular time period of a last received synchronization signal. The particular integer multiple is greater than one. The method further includes synchronizing a clock of the wake-up receiver to a clock of the wake-up transmitter based on at least one of the synchronization signals.

According to another example of the techniques disclosed herein, a non-transitory computer-readable medium includes instructions for operating a station in a wireless network. The instructions, when executed by a processor within the station, cause the processor to perform operations including periodically transitioning a wake-up receiver into a receive mode according to a particular interval. The station includes primary protocol circuitry operating according to a first protocol and low-power protocol circuitry operating according to a low-power protocol. The wake-up receiver is included in the low-power protocol circuitry. The operations also include receiving, at the wake-up receiver, synchronization signals from a wake-up transmitter of an access point in the wireless network. Each synchronization signal is received within a particular time period of a last received synchronization signal. The particular integer multiple is greater than one. The operations also include synchronizing a clock of the wake-up receiver to a clock of the wake-up transmitter based on at least one of the synchronization signals.

According to another example of the techniques disclosed herein, a station configured to operate in a wireless network includes means for operating according to a low-power protocol coupled to means for operating according to a first protocol. The means for operating according to the low-power protocol includes means for periodically transitioning into a receive mode according to a particular interval and for receiving synchronization signals from a wake-up transmitter of an access point in the wireless network. Each synchronization signal is received within a particular time period of a last received synchronization signal. The particular integer multiple is greater than one. The means for operating according to the low-power protocol also includes means for synchronizing a clock of the wake-up receiver to a clock of the wake-up transmitter based on at least one of the synchronization signals.

According to another example of the techniques disclosed herein, an access point configured to operate in a wireless network includes low-power protocol circuitry configured to operate according to a low-power protocol coupled to primary protocol circuitry configured to operate according to a first protocol. The low-power protocol circuitry includes a wake-up transmitter configured to determine a particular interval that a wake-up receiver of a station in the wireless network periodically transitions into a receive mode. The wake-up transmitter is further configured to transmit synchronization signals to the wake-up receiver according to the particular interval. Each synchronization signal is transmitted within a particular time period of a last transmitted synchronization signal.

According to another example of the techniques disclosed herein, a method of operating an access point in a wireless network includes determining, at a low-power processor, a particular interval that a wake-up receiver of a station in the wireless network periodically transitions into a receive mode. The access point includes low-power circuitry operating according to a low-power protocol and primary protocol circuity operating according to a first protocol. The low-power circuitry includes the low-power processor and a wake-up transmitter. The method also includes transmitting, at the wake-up transmitter, synchronization signals to the wake-up receiver according to the particular interval. Each synchronization signal is transmitted within a particular time period of a last transmitted synchronization signal.

According to another example of the techniques disclosed herein, a non-transitory computer-readable medium includes instruction for operating an access point in a wireless network. The instructions, when executed by a processor within the access point, cause the processor to perform operations including determining, at a low-power processor, a particular interval that a wake-up receiver of a station in the wireless network periodically transitions into a receive mode. The access point includes low-power circuitry operating according to a low-power protocol and primary protocol circuity operating according to a first protocol. The low-power circuitry includes the low-power processor and a wake-up transmitter. The operations also include transmitting, at the wake-up transmitter, synchronization signals to the wake-up receiver according to the particular interval. Each synchronization signal is transmitted within a particular time period of a last transmitted synchronization signal.

According to another example of the techniques disclosed herein, an access point configured to operate in a wireless network includes means for operating according to a low-power protocol coupled to means for operating according to a first protocol. The means for operating according to the low-power protocol includes means for determining a particular interval that a wake-up receiver of a station in the wireless network periodically transitions into a receive mode and for transmitting synchronization signals to the wake-up receiver according to the particular interval. Each synchronization signal is transmitted within a particular time period of a last transmitted synchronization signal.

According to another example of the techniques disclosed herein, a station configured to operate in a wireless network includes low-power protocol circuity configured to operate according to a low-power protocol coupled to primary protocol circuitry configured to operate according to a first protocol. The low-power protocol circuitry includes a wake-up receiver configured to transition into a receive mode at pseudorandom time intervals available to the wake-up receiver and to a wake-up transmitter of an access point in the wireless network. The wake-up receiver is also configured to receive synchronization signals from the wake-up transmitter. Each synchronization signal is received within a particular time period of a last received synchronization signal. The low-power protocol circuitry also includes a low-power processor configured to synchronize a clock of the wake-up receiver to a clock of the wake-up transmitter based on at least one of the synchronization signals.

According to another example of the techniques disclosed herein, a method of operating a station in a wireless network include transitioning a wake-up receive into a receive mode at pseudorandom time intervals available to the station and to an access point in the wireless network. A time period of each pseudorandom time interval is less than a threshold time. The station includes primary protocol circuitry operating according to a first protocol and low-power protocol circuitry operating according to a low-power protocol. The wake-up receiver is included in the low-power protocol circuitry. The method also includes receiving, at the wake-up receiver, synchronization signals from a wake-up transmitter of the access point. Each synchronization signal is received within a particular time period of a last received synchronization signal. The particular integer multiple is greater than one. The method further includes synchronizing a clock of the wake-up receiver to a clock of the wake-up transmitter based on at least one of the synchronization signals.

According to another example of the techniques disclosed herein, a non-transitory computer-readable medium includes instructions for operating a station in a wireless network. The instructions, when executed by a processor within the station, cause the processor to perform operations including transitioning a wake-up receive into a receive mode at pseudorandom time intervals available to the station and to an access point in the wireless network. A time period of each pseudorandom time interval is less than a threshold time. The station includes primary protocol circuitry operating according to a first protocol and low-power protocol circuitry operating according to a low-power protocol. The wake-up receiver is included in the low-power protocol circuitry. The operations also include receiving, at the wake-up receiver, synchronization signals from a wake-up transmitter of the access point. Each synchronization signal is received within a particular time period of a last received synchronization signal. The particular integer multiple is greater than one. The operations further include synchronizing a clock of the wake-up receiver to a clock of the wake-up transmitter based on at least one of the synchronization signals.

According to another example of the techniques disclosed herein, a station configured to operate in a wireless network includes means for operating according to a low-power protocol coupled to means for operating according to a first protocol. The means for operating according to the low-power protocol includes means for transitioning into a receive mode at pseudorandom time intervals available for receiving synchronization signals from a wake-up transmitter. Each synchronization signal is received within a particular time period of a last received synchronization signal. The means for operating according to the low-power protocol also includes means for synchronizing a clock of the wake-up receiver to a clock of the wake-up transmitter based on at least one of the synchronization signals.

According to another example of the techniques disclosed herein, an access point configured to operate in a wireless network includes low-power protocol circuitry configured to operate according to a low-power protocol coupled to primary protocol circuitry configured to operate according to a first protocol. The low-power protocol circuitry includes a wake-up transmitter configured to determine pseudorandom time intervals that a wake-up receiver of a station in the wireless network transitions into a receive mode. The wake-up transmitter is also configured to transmit synchronization signals to the wake-up receiver according to the pseudorandom time intervals. Each synchronization signal is transmitted within a particular time period of a last transmitted synchronization signal.

According to another example of the techniques disclosed herein, a method of operating an access point in a wireless network includes determining, at a low-power processor, pseudorandom time intervals that a wake-up receiver of a station in the wireless network transitions into a receive mode. The access point includes low-power circuitry operating according to a low-power protocol and primary protocol circuity operating according to a first protocol. The low-power circuitry includes the low-power processor and a wake-up transmitter. The method also includes transmitting, at the wake-up transmitter, synchronization signals to the wake-up receiver according to the pseudorandom time intervals. Each synchronization signal is transmitted within a particular time period of a last transmitted synchronization signal.

According to another example of the techniques disclosed herein, a non-transitory computer-readable medium includes instructions for operating an access point in a wireless network. The instructions, when executed by a processor within the access point, cause the processor to perform operations including determining, at a low-power processor, pseudorandom time intervals that a wake-up receiver of a station in the wireless network transitions into a receive mode. The access point includes low-power circuitry operating according to a low-power protocol and primary protocol circuity operating according to a first protocol. The low-power circuitry includes the low-power processor and a wake-up transmitter. The operations also include transmitting, at the wake-up transmitter, synchronization signals to the wake-up receiver according to the pseudorandom time intervals. Each synchronization signal is transmitted within a particular time period of a last transmitted synchronization signal.

According to another example of the techniques disclosed herein, an access point configured to operate in a wireless network includes means for operating according to a low-power protocol coupled to means for operating according to a first protocol. The means for operating according to the low-power protocol includes means for determining pseudorandom time intervals that a wake-up receiver of a station in the wireless network transitions into a receive mode and for transmitting synchronization signals to the wake-up receiver according to the pseudorandom time intervals. Each synchronization signal is transmitted within a particular time period of a last transmitted synchronization signal.

According to another example of the techniques disclosed herein, a station configured to operate in a wireless network includes primary protocol circuitry configured to operate according to a first protocol coupled to low-power protocol circuitry configured to operate according to a low-power protocol. The primary protocol circuitry includes a receiver configured to receive beacons from a transmitter of an access point in the wireless network according to a particular interval. The low-power protocol circuitry includes a wake-up receiver configured to transition into a receive mode to receive synchronization signals from a wake-up transmitter of the access point. Each synchronization signal is received within a particular time period of a last received synchronization signal and following a beacon transmission for the access point. The low-power protocol circuitry also includes a low-power processor configured to synchronize a clock of the wake-up receiver to a clock of the wake-up transmitter based on at least one of the synchronization signals.

According to another example of the techniques disclosed herein, a method of operating a station in a wireless network includes receiving, at a receiver of the station, beacons from a transmitter of an access point in the wireless network according to a particular interval. The station includes primary protocol circuitry operating according to a first protocol, and the receiver is included in the primary protocol circuitry. The method also includes transitioning a wake-up receiver into a receive mode to receiver synchronization signals from a wake-up transmitter of the access point. Each synchronization signal is received within a particular time period of a last received synchronization signal and following a beacon transmission for the access point. The station includes low-power protocol circuitry operating according to a low-power protocol, and the wake-up receiver is included in the low-power protocol circuitry. The method also includes synchronizing a clock of the wake-up receiver to a clock of the wake-up transmitter based on at least one of the synchronization signals.

According to another example of the techniques disclosed herein, a non-transitory computer-readable medium includes instructions for operating a station in a wireless network. The instructions, when executed by a processor within the station, cause the processor to perform operations including receiving, at a receiver of the station, beacons from a transmitter of an access point in the wireless network according to a particular interval. The station includes primary protocol circuitry operating according to a first protocol, and the receiver is included in the primary protocol circuitry. The operations also include transitioning a wake-up receiver into a receive mode to receive synchronization signals from a wake-up transmitter of the access point. Each synchronization signal is received within a particular time period of a last received synchronization signal and following a beacon transmission for the access point. The station includes low-power protocol circuitry operating according to a low-power protocol, and the wake-up receiver is included in the low-power protocol circuitry. The operations also include synchronizing a clock of the wake-up receiver to a clock of the wake-up transmitter based on at least one of the synchronization signals.

According to another example of the techniques disclosed herein, a station configured to operate in a wireless network includes means for operating according to a first protocol coupled to means for operating according to a low-power protocol. The means for operating according to the first protocol includes means for receiving beacons from a transmitter of an access point in the wireless network according to a particular interval. The means for operating according to the low-power protocol includes means for transitioning into a receive mode to receive synchronization signals from a wake-up transmitter of the access point. Each synchronization signal is received within a particular time period of a last received synchronization signal and following a beacon transmission from the access point. The means for operating according to the low-power protocol also includes means for synchronizing a clock of the wake-up receiver to a clock of the wake-up transmitter based on at least one of the synchronization signals.

According to another example of the techniques disclosed herein, an access point configured to operate in a wireless network includes primary protocol circuitry configured to operate according to a first protocol coupled to low-power protocol circuitry configured to operate according to a low-power protocol. The primary protocol circuitry includes a transmitter configured to transmit beacons to a receiver of a station in the wireless network according to a particular interval. The low-power protocol circuity includes a wake-up transmitter configured to determine a second particular interval that a wake-up receiver of the station transitions into a receive mode. The second particular interval is based on the particular interval. The wake-up transmitter is also configured to transmit synchronization signals to the wake-up receiver according to the second particular interval. Each synchronization signal is transmitted within a particular time period of a last transmitted synchronization signal and following transmission of a beacon.

According to another example of the techniques disclosed herein, a method of operating an access point in a wireless network includes transmitting, at a transmitter of the access point, beacons to a receiver of a station in the wireless network according to a particular interval. The access point includes primary protocol circuity operating according to a first protocol, and the transmitter is included in the primary protocol circuitry. The method also includes determining, at a wake-up transmitter, a second particular interval that a wake-up receiver of the station transitions into a receive mode. The second particular interval is based on the particular interval. The access point also includes low-power protocol circuitry operating according to a low-power protocol, and the wake-up transmitter is included in the low-power protocol circuitry. The method further includes transmitting, at the wake-up transmitter, synchronization signals to the wake-up receiver according to the second particular interval. Each synchronization signal is transmitted within a particular time period of a last transmitted synchronization signal and following transmission of a beacon.

According to another example of the techniques disclosed herein, a non-transitory computer-readable medium includes instruction for operating an access point in a wireless network. The instructions, when executed by a processor within the access point, cause the processor to perform operations including transmitting, at a transmitter of the access point, beacons to a receiver of a station in the wireless network according to a particular interval. The access point includes primary protocol circuity operating according to a first protocol, and the transmitter is included in the primary protocol circuitry. The operations also include determining, at a wake-up transmitter, a second particular interval that a wake-up receiver of the station transitions into a receive mode. The second particular interval is based on the particular interval. The access point also includes low-power protocol circuitry operating according to a low-power protocol, and the wake-up transmitter is included in the low-power protocol circuitry. The operations further include transmitting, at the wake-up transmitter, synchronization signals to the wake-up receiver according to the second particular interval. Each synchronization signal is transmitted within a particular time period of a last transmitted synchronization signal and following transmission of a beacon.

According to another example of the techniques disclosed herein, an access point configured to operate in a wireless network includes low-power protocol circuitry configured to operate according to a low-power protocol and primary protocol circuity configured to operate according to a first protocol. The low-power protocol circuitry includes a wake-up transmitter configured to determine a particular time interval that each wake-up receiver of a plurality of target stations is in a receive mode. The wake-up transmitter is also configured transmit a message to each wake-up receiver of the plurality of target stations during the particular time interval.

According to another example of the techniques disclosed herein, a method of operating an access point in a wireless network includes determining, at a low-power processor, a particular time interval that each wake-up receiver of a plurality of target stations is in a receive mode. The access point includes low-power circuitry operating according to a low-power protocol and primary protocol circuitry operating according to a first protocol. The low-power circuitry includes the low-power processor and a wake-up transmitter. The method also includes transmitting, at the wake-up transmitter, a message to each wake-up receiver of the plurality of target stations during the particular time interval.

According to another example of the techniques disclosed herein, a non-transitory computer-readable medium includes instruction for operating an access point in a wireless network. The instructions, when executed by a processor within the access point, cause the processor to perform operations including determining, at a low-power processor, a particular time interval that each wake-up receiver of a plurality of target stations is in a receive mode. The access point includes low-power circuitry operating according to a low-power protocol and primary protocol circuitry operating according to a first protocol. The low-power circuitry includes the low-power processor and a wake-up transmitter. The operations also include transmitting, at the wake-up transmitter, a message to each wake-up receiver of the plurality of target stations during the particular time interval.

According to another example of the techniques disclosed herein, an access point configured to operate in a wireless network include means for operating according to a low-power protocol and means for operating according to a first protocol. The means for operating according to the low-power protocol include means for determining a particular time interval that each wake-up receiver of a plurality of target stations is in a receive mode. The means for operating according to the low-power protocol also include means for transmitting a message to each wake-up receiver of the plurality of target stations during the particular time interval.

According to another example of the techniques disclosed herein, an access point configured to operate in a wireless network includes low-power protocol circuitry configured to operate according to a low-power protocol and primary protocol circuity configured to operate according to a first protocol. The low-power protocol circuitry includes a wake-up transmitter configured to determine a first particular time interval that a first wake-up receiver of a first station is in a receive mode and a second particular time interval that a second wake-up receiver of a second station is in a receive mode. The wake-up transmitter is also configured to unicast a first message to the first wake-up receiver during the first particular time interval. The wake-up transmitter is further configured to unicast a second message to the second wake-up receiver during the second particular time interval.

According to another example of the techniques disclosed herein, a method of operating an access point in a wireless network includes determining, at a low-power processor, a first particular time interval that a first wake-up receiver of a first station is in a receive mode and a second particular time interval that a second wake-up receiver of a second station is in a receive mode. The access point includes low-power circuitry operating according to a low-power protocol and primary protocol circuitry operating according to a first protocol. The low-power circuitry includes the low-power processor and a wake-up transmitter. The method also includes unicasting, at the wake-up transmitter, a first message to the first wake-up receiver during the first particular time interval. The method also includes unicasting a second message to the second wake-up receiver during the second particular time interval.

According to another example of the techniques disclosed herein, a non-transitory computer-readable medium includes instruction for operating an access point in a wireless network. The instructions, when executed by a processor within the access point, cause the processor to perform operations including determining, at a low-power processor, a first particular time interval that a first wake-up receiver of a first station is in a receive mode and a second particular time interval that a second wake-up receiver of a second station is in a receive mode. The access point includes low-power circuitry operating according to a low-power protocol and primary protocol circuitry operating according to a first protocol. The low-power circuitry includes the low-power processor and a wake-up transmitter. The operations also include unicasting, at the wake-up transmitter, a first message to the first wake-up receiver during the first particular time interval. The operations also include unicasting a second message to the second wake-up receiver during the second particular time interval.

According to another example of the techniques disclosed herein, an access point configured to operate in a wireless network includes low-power protocol circuitry configured to operate according to a low-power protocol and primary protocol circuity configured to operate according to a first protocol. The low-power protocol circuitry includes a wake-up transmitter configured to determine a first particular time interval that a first wake-up receiver of a first station is in a receive mode. A plurality of target stations includes the first station and one or more other stations. The wake-up transmitter is also configured to determine a second particular time interval that each wake-up receiver of the one or more other stations is a receive mode. The first particular time interval precedes the second particular time interval. The wake-up transmitter is also configured to unicast a first message to the first wake-up receiver during the first particular time interval. The wake-up transmitter is further configured to send a second message to each wake-up receiver of the one or more other stations during the second particular time interval.

According to another example of the techniques disclosed herein, a method of operating an access point in a wireless network includes determining, at a low-power processor, a first particular time interval that a first wake-up receiver of a first station is in a receive mode. A plurality of target stations includes the first station and one or more other stations. The access point includes low-power circuitry operating according to a low-power protocol and primary protocol circuitry operating according to a first protocol. The low-power circuitry includes the low-power processor and a wake-up transmitter. The method also includes determining a second particular time interval that each wake-up receiver of the one or more other stations is a receive mode. The first particular time interval precedes the second particular time interval. The method further includes unicasting a first message to the first wake-up receiver during the first particular time interval. The method further includes sending a second message to each wake-up receiver of the one or more other stations during the second particular time interval.

According to another example of the techniques disclosed herein, a non-transitory computer-readable medium includes instruction for operating an access point in a wireless network. The instructions, when executed by a processor within the access point, cause the processor to perform operations including determining, at a low-power processor, a first particular time interval that a first wake-up receiver of a first station is in a receive mode. A plurality of target stations includes the first station and one or more other stations. The access point includes low-power circuitry operating according to a low-power protocol and primary protocol circuitry operating according to a first protocol. The low-power circuitry includes the low-power processor and a wake-up transmitter. The operations also include determining a second particular time interval that each wake-up receiver of the one or more other stations is a receive mode. The first particular time interval precedes the second particular time interval. The operations further include unicasting a first message to the first wake-up receiver during the first particular time interval. The operations further include sending a second message to each wake-up receiver of the one or more other stations during the second particular time interval.

### V. BRIEF DESCRIPTION OF THE DRAWINGS

FIG. 1 is a diagram of a system that is operable to support wake-up receiver scheduling for a low-power protocol;

FIG. 2 illustrates a timing diagram of a station and a timing diagram of an access point according to a first implementation of the techniques disclosed herein;

FIG. 3 illustrates a timing diagram of a station and a timing diagram of an access point according to a second implementation of the techniques disclosed herein;

FIG. 4 illustrates a timing diagram of a station and a timing diagram of an access point according to a third implementation of the techniques disclosed herein;

FIG. 5 illustrates a timing diagram of a station and a timing diagram of an access point according to a fourth implementation of the techniques disclosed herein;

FIG. 6 is a method of operating a station in a wireless network according to the first implementation;

FIG. 7 is a method of operating an access point in a wireless network according to the first implementation;

FIG. 8 is a method of operating a station in a wireless network according to the second implementation;

FIG. 9 is a method of operating an access point in a wireless network according to the second implementation;

FIG. 10 is a method of operating a station in a wireless network according to the third implementation;

FIG. 11 is a method of operating an access point in a wireless network according to the third implementation;

FIG. 12 is a method of operating a station in a wireless network according to the fourth implementation;

FIG. 13 is a method of operating an access point in a wireless network according to the fourth implementation;

FIG. 14 illustrates timing diagrams of stations and a timing diagram of an access point according to a fifth implementation of the techniques disclosed herein;

FIG. 15 illustrates timing diagrams of stations and a timing diagram of an access point according to a sixth implementation of the techniques disclosed herein;

FIG. 16 illustrates timing diagrams of stations and a timing diagram of an access point according to a seventh implementation of the techniques disclosed herein;

FIG. 17 is a method of operating an access point in a wireless network according to the fifth implementation;

FIG. 18 is a method of operating an access point in a wireless network according to the sixth implementation;

FIG. 19 is a method of operating an access point in a wireless network according to the seventh implementation; and

FIG. 20 is a diagram of a device that is operable to support various implementations of one or more methods, systems, apparatuses, and/or computer-readable media disclosed herein.

### VI. DETAILED DESCRIPTION

Particular implementations of the present disclosure are described with reference to the drawings. In the description, common features are designated by common reference numbers throughout the drawings.

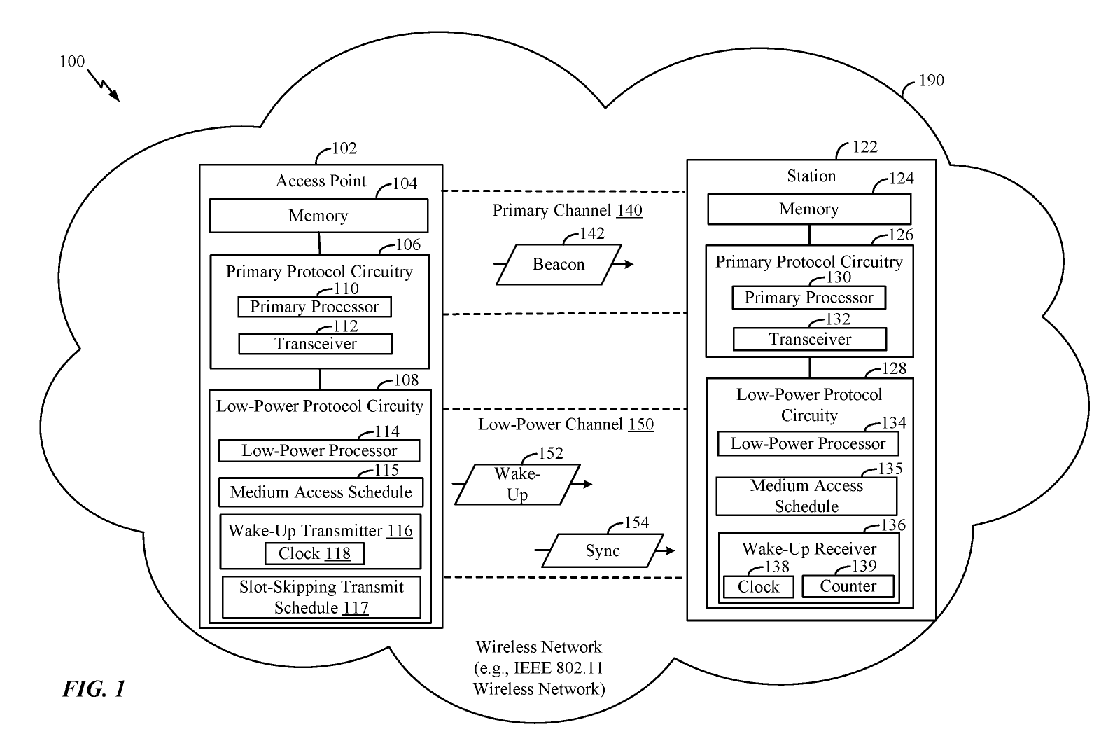

Referring to FIG. 1, a system 100 that is operable to support a low-power protocol for managing power in a wireless network is shown. The system 100 includes an access point 102 and a station 122 (e.g., a mobile device). It should be noted that additional (or fewer) access points may be present in the system 100. Additionally, it should be noted that although FIG. 1 depicts a single mobile device (e.g., the station 122), any number of mobile devices may be present in the system 100. The access point 102 and the station 122 may operate in compliance with one or more Institute of Electrical and Electronics Engineers (IEEE) 802.11 standards. As used herein, “IEEE 802.11” may be used interchangeably with “Wi-Fi”.

The access point 102 may be a node of a wireless network 190 (e.g., an IEEE 802.11 wireless network). For example, the access point 102 may be an IEEE 802.11 access point that supports (e.g., manages) the wireless network 190. The access point 102 includes a memory 104, primary protocol circuitry 106, and low-power protocol circuitry 108. The primary protocol circuitry 106 includes a primary processor 110 and a transceiver 112. The low-power protocol circuitry 108 includes a low-power processor 114, a medium access schedule 115, a wake-up transmitter 116, and a slot-skipping transmit schedule 117. The wake-up transmitter 116 includes a clock 118. The memory 104 may be a non-transitory computer-readable medium that includes instructions that are executable by one or more processors 110, 114.

The primary protocol circuity 106 may operate according to a first protocol, and the low-power protocol circuitry 108 may operate according to a low-power protocol. As used herein, one example of the first protocol may be an IEEE 802.11 protocol.

The station 122 includes a memory 124, primary protocol circuitry 126, and low-power protocol circuitry 128. The primary protocol circuitry 126 includes a primary processor 130 and a transceiver 132. The low-power protocol circuitry 128 includes a low-power processor 134, a medium access schedule 135, and a wake-up receiver 136. The wake-up receiver 136 includes a clock 138 and a counter 139. The memory 124 may be a non-transitory computer-readable medium that includes instructions that are executable by one or more processors 130, 134.

The access point 102 may be configured to communicate with the station 122 using a primary channel 140 and a low-power channel 150. The primary channel 140 may operate according to the first protocol (e.g., a Wi-Fi protocol) and the low-power channel 150 may operate according the low-power protocol. The primary processor 110 may be configured to generate data that is communicated from the access point 102 to the station 122 via the primary channel 140, and the transceiver 112 may be configured to send the generated data to the station 122 via the primary channel 140. The transceiver 132 may receive the data and provide the received data to the primary processor 130 for processing. In a similar manner, the primary processor 130 may be configured to generate data that is communicated from the station 122 to the access point 102 via the primary channel 140, and the transceiver 132 may be configured to send the generated data to the access point 102 via the primary channel 140. The transceiver 112 may receive the data and provide the received data to the primary processor 110 for processing. The transceiver 112 may also be configured to send management messages and/or data, such as a beacon 142 to announce the presence of the wireless network 190 to devices within range of the beacon 142.

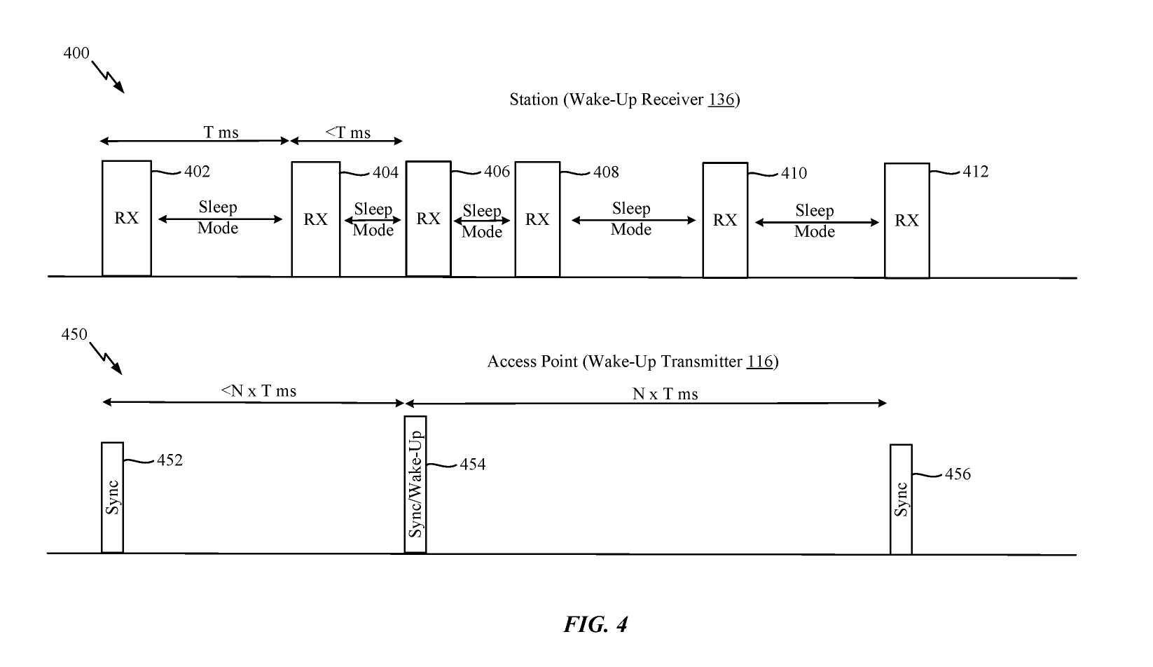

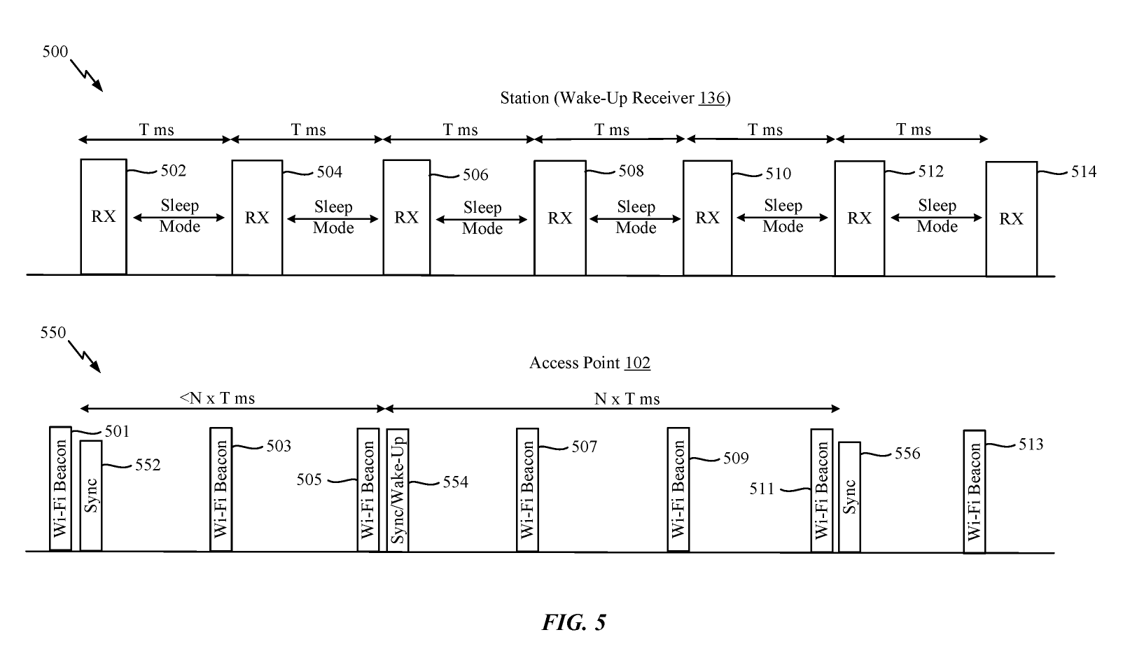

The low-power processor 114 may be configured to generate data that is communicated from the access point 102 to the station 122 via the low-power channel 150, and the wake-up transmitter 116 may be configured to send the generated data to the station 122 via the low-power channel 150 according to the medium access schedule 115. The wake-up receiver 136 may receive the data and provide the data to the low-power processor 134 for processing. As described below, the wake-up receiver 136 may be in a receive mode or a sleep mode. For example, the wake-up receiver 136 may periodically transition from sleep mode into the receive mode. To illustrate, the low-power processor 134 may load the counter 139 of the wake-up receiver 136 with a fixed value, and the wake-up receiver 136 may transition into the receive mode in response to the counter 139 counting to zero from the fixed value based on the clock 138 (e.g., a low-power oscillator). Thus, the counter 139 and the clock 138 may be used to measure the time between receive modes of the wake-up receiver 136. According to one implementation, the wake-up receiver 136 may wake-up (e.g., transition into receive mode) according to a medium access schedule 135 that indicates a schedule of “slots” during which the wake-up receiver 136 is to function in the receive mode. According to another implementation, the transceiver 112 may transmit beacons 142 via the primary channel 140, and the wake-up receiver 136 may transition into the receive mode during a time period that follows the transmission of the beacon 142 from the access point 102. Additional detail of this implementation is provided with respect to FIG. 5.

During the receive mode, the wake-up receiver 136 may listen for and receive data (e.g., wake-up messages 152, synchronization signals 154, or a combination thereof) from the wake-up transmitter 116 via the low-power channel 150. In response to receiving a wake-up message 152 at the wake-up receiver 136, the low-power processor 134 may send an activation signal to the primary protocol circuity 126 to switch the primary protocol circuitry 126 from sleep mode to active mode. In response to receiving a synchronization signal 154 (or the wake-up message 152) at the wake-up receiver 136, the low-power processor 134 may synchronize the clock 138 with the clock 118. The synchronization signal 154 may be transmitted to each station in the wireless network 190 (e.g., a Wi-Fi Basic Service Set (BSS)) because it is beneficial for each station to maintain synchronization with the access point 102. The wake-up message 152 may be transmitted to an individual station (e.g., the station 122), a group of stations, or every station in the wireless network 190.

According to some implementations, the wake-up receiver 136 may be configured to send a signal (to a component in the sleep mode) indicating that a packet preamble has not been detected during the receive mode because the wake-up receiver 136 can determine the worst case clock drift, the duration of the packet preamble, and the processing time to detect the preamble. As a result, the wake-up receiver 136 may determine to change from the receive mode to sleep mode and save additional power. If the packet preamble is substantially less than the length of the synchronization signal 154 (or the wake-up message 152) and the packet detection processing time is low, the duration of the receive mode may be lower substantially when neither the synchronization signal 154 or the wake-up message 152 is received.

Because the clock 138 may drift from synchronization with the clock 118, the synchronization signal 154 may be sent by the access point 102 during time slots indicated in the medium access schedule 115 (e.g., during time slots when the wake-up receiver 136 is in the receive mode). A longest delay between successive synchronization signals 154 may be determined by a “worst case” clock drift condition. To conserve power and medium resources, the access point 102 may generate the slot-skipping transmit schedule 117 to transmit synchronization signals 154 during some slots of the medium access schedule 115, but not during other slots of the medium access schedule 115 (e.g., “skipping” slots), under the constraint that the largest allowable delay between synchronization signals 154 is not exceeded. As a result, the wake-up receiver 132 listens during each slot, but the wake-up transmitter 116 transmits on less than every slot.

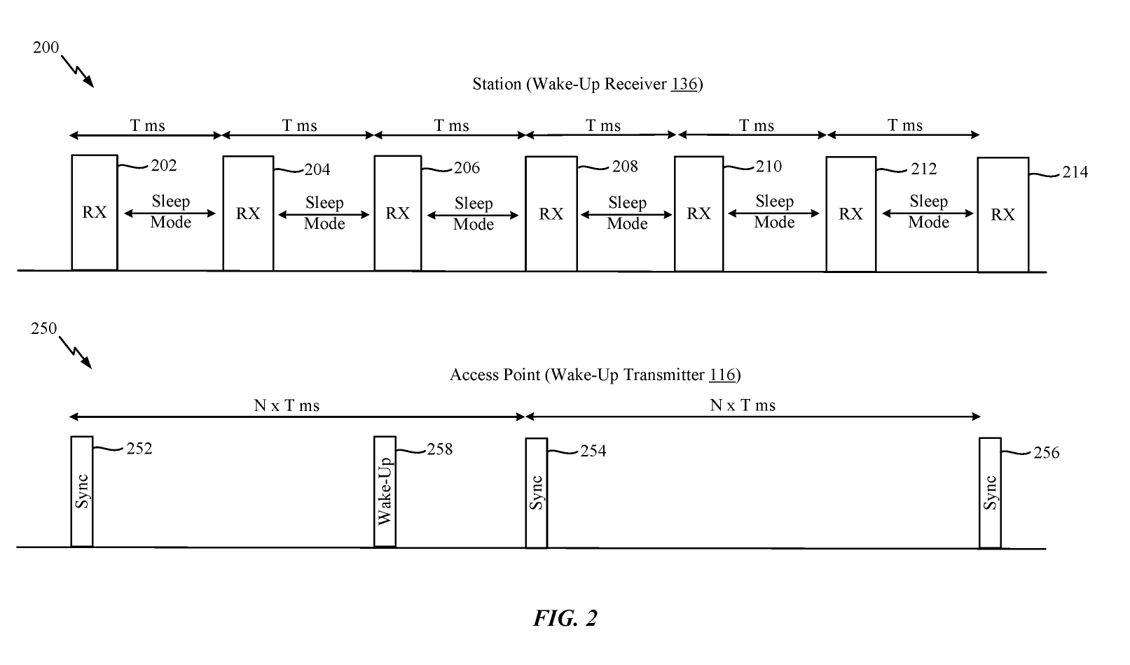

Communication between the wake-up transmitter 116 and the wake-up receiver 136 of FIG. 1 is described in greater detail with respect to FIGS. 2-5. For example, FIGS. 2-5 include timing diagrams illustrating data communication between the wake-up transmitter 116 and the wake-up receiver 136.

Referring to FIG. 2, a timing diagram 200 of the wake-up receiver 136 and a timing diagram 250 of the wake-up transmitter 116 according to a first implementation is shown.

According to the timing diagram 200, the wake-up receiver 136 may be configured to periodically transition into a receive mode according to a particular interval. The particular interval may be equal to T milliseconds (ms). As a non-limiting example, T may be equal to 100. Thus, the wake-up receiver 136 may periodically transition into the receive mode every 100 ms, which would lead to a “worst” case latency of 100 ms for receiving a wake-up message (e.g., the wake-up message 152 of FIG. 1). According to the timing diagram 200, the wake-up receiver 136 may transition between receive mode (RX) during time slots 202, 204, 206, 208, 210, 212, 214 and sleep mode every T ms.

According to the timing diagram 250, the wake-up transmitter 116 may be configured to determine the particular interval that the wake-up receiver 136 periodically transitions into the receive mode. For example, the wake-up transmitter 116 may determine that the wake-up receiver 136 transitions into the receive mode (RX) during the time slots 202, 204, 206, 208, 210, 212, 214 every T ms. To illustrate, the wake-up transmitter 116 may access the medium access schedule 115 to determine the particular interval that the wake-up receiver 136 “listens in” on the low-power channel 150. In other implementations, the station 122 may communicate the particular interval to the access point 102 via the primary channel 140, the access point 102 may determine the particular interval and communicate the particular interval to the station 122 (e.g., the wake-up receiver 136), the particular interval may be defined by an industry standard (e.g., an IEEE 802.11 standard, etc.), or a combination thereof.

After determining the particular interval, the wake-up transmitter 136 may be configured to transmit synchronization signals 252, 254, 256 to the wake-up receiver 116 at a particular integer multiple (N) of the particular interval. The particular integer multiple (N) may be greater than one, such that the synchronization signals 252, 254, 256 are not sent every time the wake-up receiver 136 transitions into the receive mode. According to the timing diagram 250, the particular integer multiple (N) is equal to 3. Thus, the wake-up transmitter 116 may transmit the synchronization signals 252, 254, 256 to the wake-up receiver 136 every 300 ms (e.g., every N×T ms). To illustrate, the wake-up transmitter 116 may transmit the synchronization signal 252 to the wake-up receiver 136 while the wake-up receiver 136 is in the receive mode during slot 202. After 300 ms, the wake-up transmitter 116 may transmit the synchronization signal 254 to the wake-up receiver 136 while the wake-up receiver 136 is in the receive mode during slot 208. After another 300 ms, the wake-up transmitter 116 may transmit the synchronization signal 256 to the wake-up receiver 136 while the wake-up receiver 136 is in the receive mode during slot 214.

Because the wake-up transmitter 116 transmits the synchronization signals 252, 254, 256 at the particular integer multiple (N) of the particular interval, the wake-up receiver 136 may be configured to receive the synchronization signals 252, 254, 256 at the particular integer multiple (N) of the particular interval. For example, the wake-up receiver 136 may receive the synchronization signals 252, 254, 256 every 300 ms. The low-power processor 134 may be configured to synchronize the clock 138 of the wake-up receiver 136 with the clock 118 of the wake-up transmitter 116 based on at least one of the synchronization signals 252, 254, 256. For example, the clock 138 may drift relative to the clock 118 between synchronization signals 252, 254, 256 because the clock 138 may have relatively low accuracy to save power. Thus, when the wake-up receiver 136 receives a synchronization signal 252, 254, 256 or the wake-up message 258, the wake-up receiver 136 may use the timing of when the signal 252, 254, 256 or message 258 is received and the content to resynchronize the clock 138 with the clock 118. This may prevent the clock 138 from drifting too far from the clock 118. By limiting the clock drift, the duration of the receive mode (e.g., the width of each slot) may be reduced.

It should be understood that three is merely a non-limiting, illustrative example of the particular integer multiple (N). In other implementations, the particular integer multiple (N) may have other values. For example, if the particular integer multiple (N) is equal to 100, then the time between the synchronization signals 252, 254, 256 would be ten seconds. As a result, the medium usages (e.g., the low-power channel 150 usage) for synchronization signals 252, 254, 256 would be relatively low.

According to the timing diagram 250, the wake-up transmitter 116 may be configured to transmit a wake-up message to the wake-up receiver 136 when the wake-up receiver 136 is in the receive mode. For example, the wake-up transmitter 116 may transmit the wake-up message 258 to the wake-up receiver 136 when the wake-up receiver 136 is in the receive mode (RX) during slot 206. According to one implementation, the wake-up transmitter 116 may determine particular slots to transmit the synchronization signals 252, 254, 256 based on the slot-skipping transmit schedule 117. As a result, the wake-up receiver 136 may be configured to receive the wake-up message 258 from the wake-up transmitter 116 when the wake-up receiver 136 is in the receive mode. The low-power processor 134 may be configured to generate an activation signal to transition the primary protocol circuitry 126 into an awake mode in response to receiving the wake-up message 258.

The duration that the wake-up receiver 136 remains in the receive mode during the slots 202, 204, 206, 208, 210, 212, 214 may be sufficiently long enough to accommodate reception of synchronization signals 252, 254, 256, wake-up messages 258, the “worst case” clock drift since the last receive mode time, or a combination thereof. Because the clock 138 can drift to be early (with respect to the clock 118), the beginning of a particular receive mode may be early enough to capture synchronization signals and wake-up messages. Additionally, because the clock 138 can drift to be late, the end of the particular receive mode may be late enough to compensate for the late clock drift.

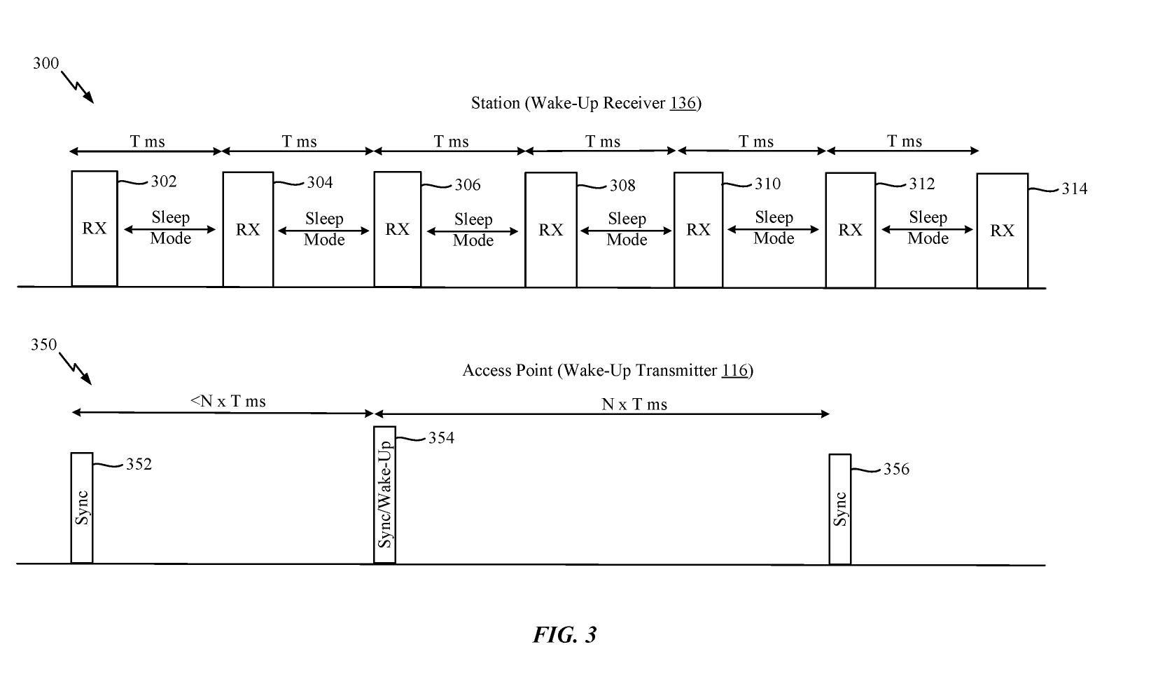

Referring to FIG. 3, a timing diagram 300 of the wake-up receiver 136 and a timing diagram 350 of the wake-up transmitter 116 according to a second implementation is shown.

According to the timing diagram 300, the wake-up receiver 136 may be configured to periodically transition into a receive mode according to the particular interval (T). According to the timing diagram 300, the wake-up receiver 136 may transition between receive mode (RX) at slots 302, 304, 306, 308, 310, 312, 314 and sleep mode every T ms.

According to the timing diagram 350, the wake-up transmitter 116 may be configured to determine the particular interval that the wake-up receiver 136 periodically transitions into the receive mode. For example, the wake-up transmitter 116 may determine that the wake-up receiver 136 transitions into the receive mode (RX) at slots 302, 304, 306, 308, 310, 312, 314 every T ms. To illustrate, the wake-up transmitter 116 may access the medium access schedule 115 to determine the particular interval that the wake-up receiver 136 “listens in” on the low-power channel 150. After determining the particular interval, the wake-up transmitter 116 may be configured to transmit synchronization signals 352, 354, 356 to the wake-up receiver 136 according to the particular interval. However, each synchronization signal may be transmitted within a particular time period of the last transmitted synchronization signal. As a non-limiting example, each synchronization signal 352, 354, 356 may be transmitted within the particular integer multiple (N) of the particular interval (T) (e.g., transmitted within 300 ms if N=3 and T=100 ms).

To illustrate, the wake-up transmitter 116 may transmit the synchronization signal 352 to the wake-up receiver 136 when the wake-up receiver 136 is in the receive mode at slot 302. Within the particular time period (e.g., within N×T ms), the wake-up transmitter 116 may transmit another synchronization signal to the wake-up receiver. For example, the wake-up transmitter 116 may transmit the synchronization signal 354 to the wake-up receiver 136 during the receive mode at slot 306 because the wake-up transmitter 116 is also scheduled to transmit a wake-up message to the wake-up receiver 136 during slot 306. Thus, radio resources may be conserved by combining a wake-up message with the synchronization signal 354 during a single transmission. In this scenario, the wake-up transmitter 116 transmits the synchronization signal 354 to the wake-up receiver 136 less than N×T ms from transmitting the synchronization signal 352. For example, wake-up transmitter 116 transmits the synchronization signal 354 approximately 200 ms after transmitting the synchronization signal 352. The next synchronization signal 356 is scheduled to be transmitted at the slot 312, but may also be transmitted earlier if another wake-up message is transmitted during slot 308 or slot 310. According to one implementation, the wake-up transmitter 116 may determine particular slots to transmit the synchronization signals 352, 354, 356 based on the slot-skipping transmit schedule 117. According to one implementation, the synchronization signal 354 may also include a wake-up message.

Because the wake-up transmitter 116 transmits the synchronization signals 352, 354, 356 within the particular time period of a last transmitted synchronization signal, the wake-up receiver 136 may be configured to receive the synchronization signals 352, 354, 356 within the particular time period of a last received synchronization signal. For example, the wake-up receiver 136 may receive the synchronization signal 354 within the particular time period (e.g., within N×T ms) of receiving the synchronization signal 352. The low-power processor 134 may be configured to synchronize the clock 138 of the wake-up receiver 136 with the clock 118 of the wake-up transmitter 116 based on at least one of the synchronization signals 352, 354, 356.

Referring to FIG. 4, a timing diagram 400 of the wake-up receiver 136 and a timing diagram 450 of the wake-up transmitter 116 according to a third implementation is shown.

According to the timing diagram 400, the wake-up receiver 136 may be configured to transition into a receive mode at pseudorandom time intervals available to the wake-up receiver 136 and to the wake-up transmitter 116. To illustrate, according to the timing diagram 400, the wake-up receiver 136 may transition between receive mode (RX) at slots 402, 404, 406, 408, 410, 412 and sleep mode at least once every T ms. For example, the time interval between the beginning of receive mode at slot 402 and the beginning of receive mode at slot 404 may be equal to T ms, and the time interval between the beginning of receive mode at slot 404 and the beginning of receive mode at slot 406 may be less than T ms.

The wake-up transmitter 116 may be configured to determine the pseudorandom time intervals that the wake-up receiver 136 transitions into the receive mode. For example, the wake-up transmitter 116 may access the medium access schedule 115 to determine the pseudorandom time intervals that the wake-up receiver 136 “listens in” on the low-power channel 150. After determining the pseudorandom time intervals that the wake-up receiver 136 transitions into the receive mode, the wake-up transmitter 116 may be configured to transmit synchronization signals 452, 454, 456 to the wake-up receiver 136 according to the pseudorandom time intervals. To illustrate, the wake-up transmitter 116 may transmit a synchronization signal 452 when the wake-up receiver 136 is in the receive mode at slot 402, transmit a synchronization signal 454 when the wake-up receiver 136 is in the receive mode at slot 406, and transmit a synchronization signal 456 when the wake-up receiver 136 is in the receive mode at slot 412. Each synchronization signal 452, 454, 456 may be transmitted within a particular time period (e.g., within N×T ms) of a last transmitted synchronization signal. For example, the synchronization signal 454 may be transmitted less than N×T ms from the synchronization signal 452, and the synchronization signal 456 may be transmitted N×T ms from the synchronization signal 456. According to one implementation, the wake-up transmitter 116 may determine particular slots to transmit the synchronization signals 452, 454, 456 based on the slot-skipping transmit schedule 117. According to one implementation, the synchronization signal 454 may also include a wake-up message.

Because the wake-up transmitter 116 transmits the synchronization signals 452, 454, 456 within the particular time period of a last transmitted synchronization signal, the wake-up receiver 136 may be configured to receive the synchronization signals 452, 454, 456 within the particular time period of a last received synchronization signal. For example, the wake-up receiver 136 may receive the synchronization signal 454 within the particular time period (e.g., within N×T ms) of receiving the synchronization signal 452. The low-power processor 134 may be configured to synchronize the clock 138 of the wake-up receiver 136 with the clock 118 of the wake-up transmitter 116 based on at least one of the synchronization signals 452, 454, 456.

Referring to FIG. 5, a timing diagram 500 of the wake-up receiver 136 and a timing diagram 550 of an access point 102 according to a fourth implementation is shown.

According to the timing diagram 550, the transceiver 112 may be configured to transmit beacons (e.g., Wi-Fi beacons 501, 503, 507, 509, 511, 513) to the transceiver 132 according a particular interval. For example, transceiver 112 may transmit a beacon to the transceiver 132 every T ms via the primary channel 140. According to the timing diagram 500, the wake-up receiver 136 may be configured to transition into a receive mode following the transceiver 112 sending a beacon. To illustrate, the wake-up receiver 136 may transition into a receive mode at slot 502 following the transceiver 112 sending the Wi-Fi beacon 501. (Note that the station 122 does not “receive” the beacon 501 while the primary transceiver 132 is in sleep mode.) The wake-up receiver 136 may transition into the other receive modes at slots 504, 506, 508, 510, 512, 514 that follow the transceiver 112 sending the Wi-Fi beacons 503, 505, 507, 509, 511, 513, respectively.

The access point 102 may be configured to determine a second particular interval that the wake-up receiver 136 transitions into the receive mode. For example, the wake-up transmitter 116 may access the medium access schedule 115 to determine the time intervals that the wake-up receiver 136 “listens in” on the low-power channel 150. The second particular interval may be based on the particular interval (T ms). For example, the second particular interval may be approximately equal to the particular interval (T ms) because the wake-up receiver 136 transitions into the receive mode after the access point 102 (e.g., the transceiver 112) sends the Wi-Fi beacons 501, 503, 505, 507, 509, 511, 513 according to the particular interval. The access point 102 may be configured to transmit synchronization signals 552, 554, 556 to the wake-up receiver 136 according to the second particular intervals. To illustrate, the wake-up transmitter 116 may transmit a synchronization signal 552 when the wake-up receiver 136 is in the receive mode at slot 502, transmit a synchronization signal 554 when the wake-up receiver 136 is in the receive mode at slot 506, and transmit a synchronization signal 556 when the wake-up receiver 136 is in the receive mode 512. Each synchronization signal 552, 554, 556 may be transmitted within a particular time period (e.g., within N×T ms) of a last transmitted synchronization signal. For example, the synchronization signal 554 may be transmitted less than N×T ms from the synchronization signal 552, and the synchronization signal 556 may be transmitted N×T ms from the synchronization signal 556. According to one implementation, the wake-up transmitter 116 may determine particular slots to transmit the synchronization signals 552, 554, 556 based on the slot-skipping transmit schedule 117. According to one implementation, the synchronization signal 554 may also include a wake-up message.

Because the wake-up transmitter 116 transmits the synchronization signals 552, 554, 556 within the particular time period of a last transmitted synchronization signal, the wake-up receiver 136 may be configured to receive the synchronization signals 552, 554, 556 within the particular time period of a last received synchronization signal. For example, the wake-up receiver 136 may receive the synchronization signal 554 within the particular time period (e.g., within N×T ms) of receiving the synchronization signal 552. The low-power processor 134 may be configured to synchronize the clock 138 of the wake-up receiver 136 with the clock 118 of the wake-up transmitter 116 based on at least one of the synchronization signals 452, 454, 456.

According to the timing diagrams 500, 550 of FIG. 5, the slots associated with the receive time of the wake-up receiver 136 are right after the access point 102 transmits the Wi-Fi beacons. Thus, because the access point 102 has captured the medium to send the beacons, the access point 102 may determine whether to send a synchronization signal or a wake-up message at the completion of the Wi-Fi beacon transmission. In this scenario, the Wi-Fi beacons may be set to protect the synchronization signals and the wake-up messages. For example, a Wi-Fi beacon may include a frame header that indicates a transmission duration that includes the duration of the beacon and also the duration of the synchronization signal. Stations receiving the beacon frame header may set a network allocation vector (NAV) that prevents the stations from accessing the medium during the transmission duration.

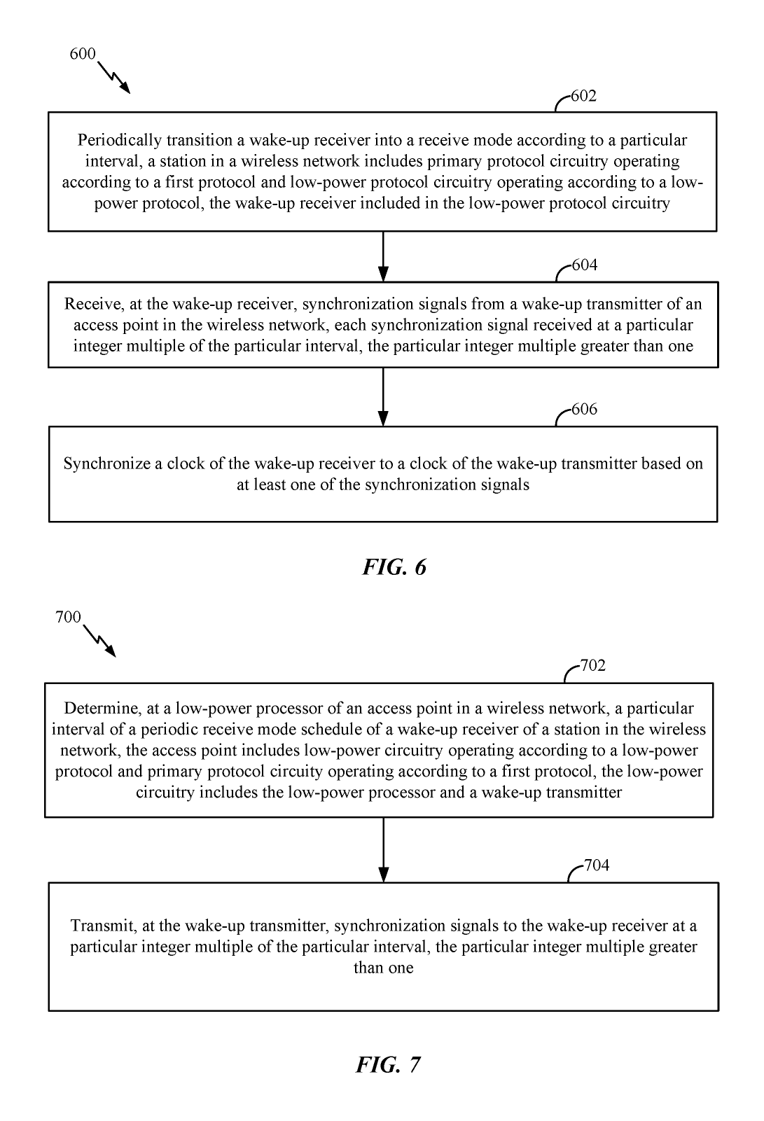

Referring to FIG. 6, a method 600 of operating a station in a wireless network is shown. The method 600 may be performed by the station 122 of FIG.1.

The method 600 includes periodically transitioning a wake-up receiver into a receive mode according to a particular interval, at 602. A station in a wireless network may include primary protocol circuitry operating according to a first protocol and low-power protocol circuitry operating according to a low-power protocol. The wake-up receiver may be included in the low-power protocol circuitry. For example, referring to FIGS. 1-2, the wake-up receiver 136 may periodically transition into the receive mode according to the particular interval (e.g., every T ms). According to the timing diagram 200, the wake-up receiver make transition between receive mode (RX) and sleep mode every T ms.

The method 600 also includes receiving, at the wake-up receiver, synchronization signals from a wake-up transmitter of an access point in the wireless network, at 604. Each synchronization signal may be received at a particular integer multiple of the particular interval, and the particular integer multiple is greater than one. For example, referring to FIGS. 1-2, because the wake-up transmitter 116 transmits the synchronization signals 252, 254, 256 at the particular integer multiple (N) of the particular interval (T ms), the wake-up receiver 136 may receive the synchronization signals 252, 254, 256 at the particular integer multiple (N) of the particular interval (T ms). For example, the wake-up receiver 136 may receive the synchronization signals 252, 254, 256 every (N×T ms).

The method 600 also includes synchronizing a clock of the wake-up receiver to a clock of the wake-up transmitter based on at least one of the synchronization signals, at 606. For example, referring to FIGS. 1-2, the low-power processor 134 may synchronize the clock 138 of the wake-up receiver 136 with the clock 118 of the wake-up transmitter 116 based on at least one of the synchronization signals 252, 254, 256.

Referring to FIG. 7, a method 700 of operating an access point in a wireless network is shown. The method 700 may be performed by the access point 102 of FIG. 1.

The method 700 includes determining, at a low-power processor of an access point in a wireless network, a particular interval of a periodic receive mode schedule of a wake-up receiver of a station in the wireless network, at 702. The access point may include low-power circuitry operating according to a low-power protocol and primary protocol circuitry operating according to a first protocol. The low-power circuitry includes the low-power processor and a wake-up transmitter. For example, referring to FIGS. 1-2, the wake-up transmitter 116 may determine the particular interval that the wake-up receiver 136 periodically transitions into the receive mode. For example, the wake-up transmitter 116 may determine that the wake-up receiver 136 transitions into the receive mode (RX) every T ms.

The method 700 also includes transmitting, at the wake-up transmitter, synchronization signals to the wake-up receiver at a particular integer multiple of the particular interval, at 704. The particular integer multiple may be greater than one. For example, referring to FIGS. 1-2, the wake-up transmitter 116 may transmit the synchronization signals 252, 254, 256 to the wake-up receiver 136 at the particular integer multiple (N) of the particular interval (T ms). The particular integer multiple (N) may be greater than one, such that the synchronization signals 252, 254, 256 are not sent every time the wake-up receiver 136 transitions into the receive mode at slots 202, 204, 206, 208, 210, 212, 214. According to the timing diagram 250, the particular integer multiple (N) is equal to 3. Thus, the wake-up transmitter 116 may transmit the synchronization signals 252, 254, 256 to the wake-up receiver 136 every 300 ms (e.g., every N×T ms).

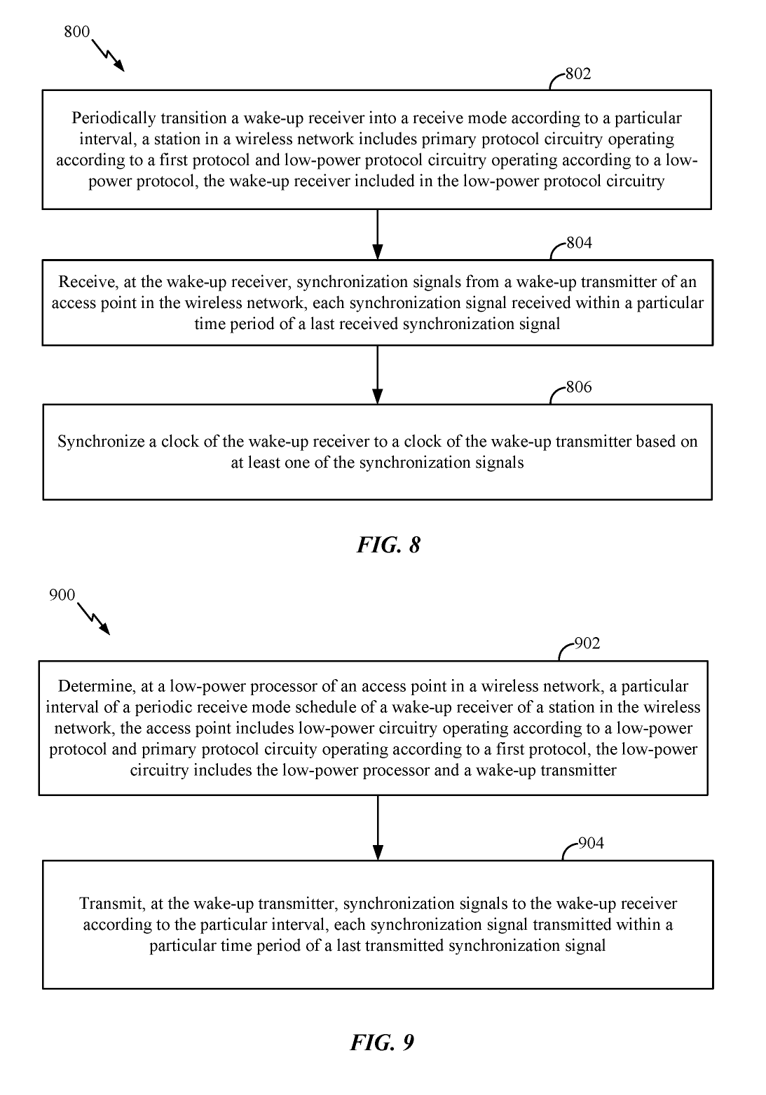

Referring to FIG. 8, another method 800 of operating a station in a wireless network is shown. The method 800 may be performed by the station 122 of FIG. 1.

The method 800 includes periodically transitioning a wake-up receiver into a receive mode according to a particular interval, at 802. A station in a wireless network may include primary protocol circuitry operating according to a first protocol and low-power protocol circuity operating according to a low-power protocol. The wake-up receiver may be included in the low-power protocol circuitry. For example, referring to FIGS. 1 and 3, the wake-up receiver 136 may periodically transition into the receive mode according to the particular interval (T). According to the timing diagram 300, the wake-up receiver 136 may transition between receive mode (RX) and sleep mode every T ms.

The method 800 also includes receiving, at the wake-up receiver, synchronization signals from a wake-up transmitter of an access point in the wireless network, at 804. Each synchronization signal may be received within a particular time period of a last received synchronization signal. For example, referring to FIGS. 1 and 3, because the wake-up transmitter 116 transmits the synchronization signals 352, 354, 356 within the particular time period (e.g., within N×T ms) of a last transmitted synchronization signal, the wake-up receiver 136 may receive the synchronization signals 352, 354, 356 within the particular time period of a last received synchronization signal. For example, the wake-up receiver 136 may receive the synchronization signal 354 within the particular time period (e.g., within N×T ms) of receiving the synchronization signal 352.

The method 800 also includes synchronizing a clock of the wake-up receiver to a clock of the wake-up transmitter based on at least one of the synchronization signals, at 806. For example, referring to FIGS. 1 and 3, the low-power processor 134 may synchronize the clock 138 of the wake-up receiver 136 with the clock 118 of the wake-up transmitter 116 based on at least one of the synchronization signals 352, 354, 356.

Referring to FIG. 9, another method 900 of operating an access point in a wireless network is shown. The method 900 may be performed by the access point 102 of FIG. 1.

The method 900 includes determining, at a low-power processor of an access point in a wireless network, a particular interval of a periodic receive mode schedule of a wake-up receiver of a station in the wireless network, at 902. The access point may include low-power circuity operating according to a low-power protocol and primary protocol circuitry operating according to a first protocol. The low-power circuitry may include the low-power processor and a wake-up transmitter. For example, referring to FIGS. 1 and 3, the wake-up transmitter 116 may determine the particular interval (T ms) that the wake-up receiver 136 periodically transitions into the receive mode. For example, the wake-up transmitter 116 may determine that the wake-up receiver 136 transitions into the receive mode (RX) at slots 302, 304, 306, 308, 310, 312, 314 every T ms.

The method 900 also includes transmitting, at the wake-up transmitter, synchronization signals to the wake-up receiver according to the particular interval, at 904. Each synchronization signal may be transmitter within a particular time period of a last transmitted synchronization signal. For example, referring to FIGS. 1 and 3, after determining the particular interval (T ms), the wake-up transmitter 116 may transmit synchronization signals 352, 354, 356 to the wake-up receiver 136 according to the particular interval (T ms). However, each synchronization signal may be transmitted within a particular time period of the last transmitted synchronization signal. As a non-limiting example, each synchronization signal 352, 354, 356 may be transmitted within the particular integer multiple (N) of the particular interval (T) (e.g., transmitted within 300 ms if N=3 and T=100 ms).

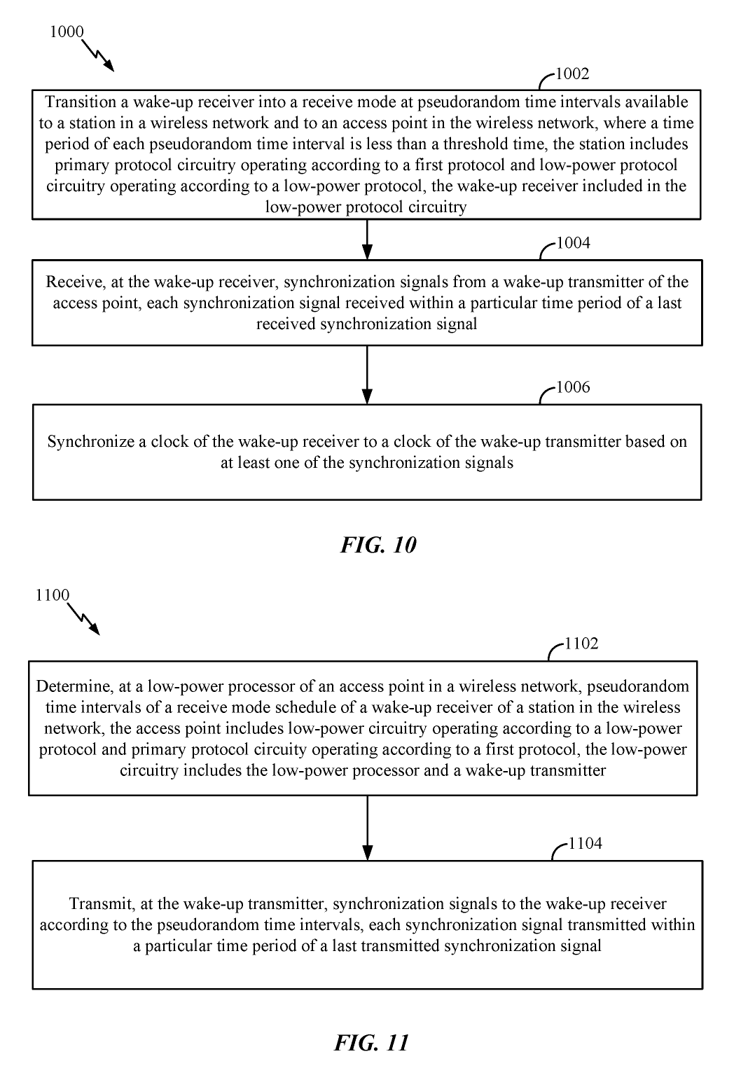

Referring to FIG. 10, another method 1000 of operating a station in a wireless network is shown. The method 1000 may be performed by the station 122 of FIG. 1.

The method 1000 includes transitioning a wake-up receiver into a receive mode at pseudorandom time intervals available to a station in a wireless network and to an access point in the wireless network, at 1002. A time period of each pseudorandom time interval may be less than a threshold time. The station may include primary protocol circuitry operating according to a first protocol and low-power protocol circuity operating according to a low-power protocol. The wake-up receiver may be included in the low-power protocol circuitry. For example, referring to FIGS. 1 and 4, the wake-up receiver 136 may transition into the receive mode at pseudorandom time intervals available to the wake-up receiver 136 and to the wake-up transmitter 116. To illustrate, according to the timing diagram 400, the wake-up receiver 136 may transition between receive mode (RX) and sleep mode at least once every T ms. For example, the time interval between the beginning of receive mode at slot 402 and the beginning of receive mode at slot 404 may be equal to T ms, and the time interval between the beginning of receive mode at slot 404 and the beginning of receive mode at slot 406 may be less than T ms.

The method 1000 also includes receiving, at the wake-up receiver, synchronization signals from a wake-up transmitter of the access point, at 1004. Each synchronization signal may be received within a particular time period of a last received synchronization signal. For example, referring to FIGS. 1 and 4, because the wake-up transmitter 116 transmits the synchronization signals 452, 454, 456 within the particular time period of a last transmitted synchronization signal, the wake-up receiver 136 may receive the synchronization signals 452, 454, 456 within the particular time period of a last received synchronization signal. For example, the wake-up receiver 136 may receive the synchronization signal 454 within the particular time period (e.g., within N×T ms) of receiving the synchronization signal 452.

The method 1000 also includes synchronizing a clock of the wake-up receiver to a clock of the wake-up transmitter based on at least one of the synchronization signals, at 1006. For example, referring to FIGS. 1 and 4, the low-power processor 134 may synchronize the clock 138 of the wake-up receiver 136 with the clock 118 of the wake-up transmitter 116 based on at least one of the synchronization signals 452, 454, 456.

Referring to FIG. 11, another method 1100 of operating an access point in a wireless network is shown. The method 1100 may be performed by the access point 102 of FIG. 1.

The method 1100 includes determining, at a low-power processor of an access point in a wireless network, pseudorandom time intervals of a receive mode schedule of a wake-up receiver of a station in the wireless network, at 1102. The access point may include low-power circuitry operating according to a low-power protocol and primary protocol circuity operating according to a first protocol. The low-power circuity may include the low-power processor and a wake-up transmitter. For example, referring to FIGS. 1 and 4, the wake-up transmitter 116 may determine the pseudorandom time intervals that the wake-up receiver 136 transitions into the receive mode. For example, the wake-up transmitter 116 may access the medium access schedule 115 to determine the pseudorandom time intervals that the wake-up receiver 136 “listens in” on the low-power channel 150.

The method 1100 also includes transmitting, at the wake-up transmitter, synchronization signals to the wake-up receiver according to the pseudorandom time intervals, at 1104. Each synchronization signal may be transmitted within a particular time period of a last transmitted synchronization signal. For example, referring to FIGS. 1 and 4, after determining the pseudorandom time intervals that the wake-up receiver 136 transitions into the receive mode, the wake-up transmitter 116 may be configured to transmit synchronization signals 452, 454, 456 to the wake-up receiver 136 according to the pseudorandom time intervals. To illustrate, the wake-up transmitter 116 may transmit the synchronization signal 452 when the wake-up receiver 136 is in the receive mode at slot 402, transmit the synchronization signal 454 when the wake-up receiver 136 is in the receive mode at slot 406, and transmit the synchronization signal 456 when the wake-up receiver 136 is in the receive mode 412. Each synchronization signal 425, 454, 456 may be transmitted within a particular time period (e.g., within N×T ms) of a last transmitted synchronization signal. For example, the synchronization signal 454 may be transmitted less than N×T ms from the synchronization signal 452, and the synchronization signal 456 may be transmitted N×T ms from the synchronization signal 456. According to one implementation, the wake-up transmitter 116 may determine particular slots to transmit the synchronization signals 452, 454, 456 based on the slot-skipping transmit schedule 117.

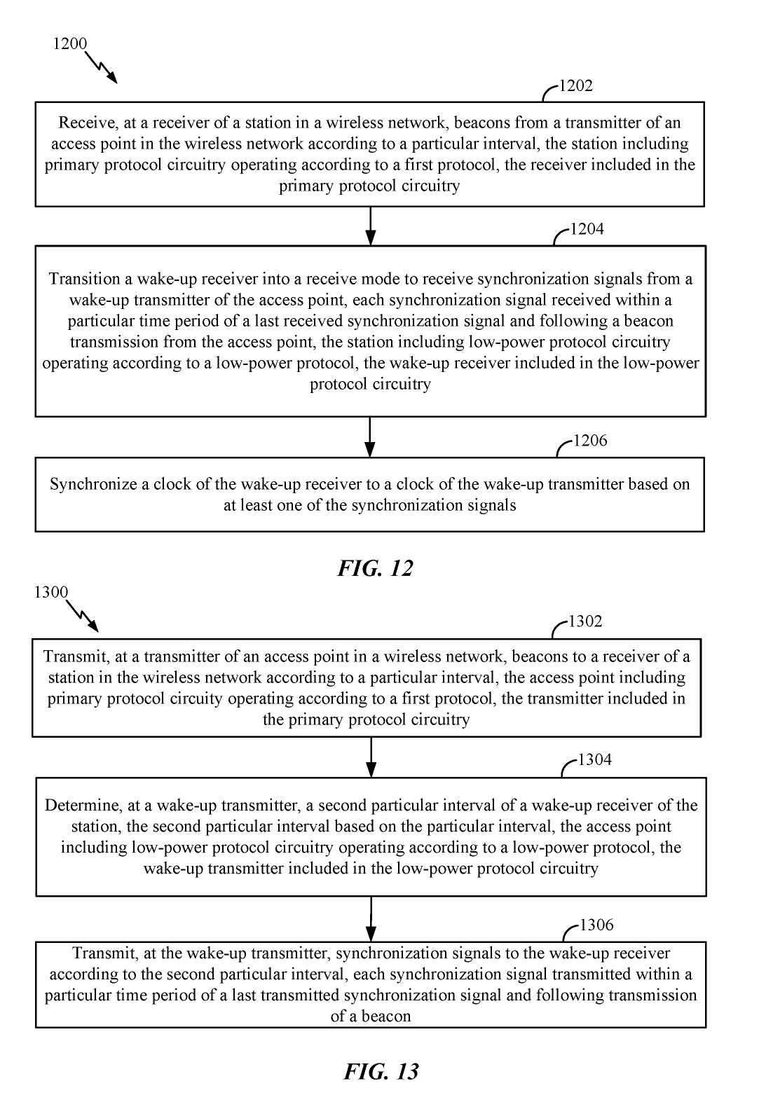

Referring to FIG. 12, another method 1200 of operating a station in a wireless network is shown. The method 1200 may be performed by the station 122 of FIG. 1.

The method 1200 includes receiving, at a receiver of a station in a wireless network, beacons from a transmitter of an access point in the wireless network according to a particular interval, at 1202. The station may include primary protocol circuitry operating according to a first protocol, and the receiver may be included in the primary protocol circuity. For example, referring to FIGS. 1 and 5, the transceiver 132 may receive Wi-Fi beacons 501, 503, 505, 507, 509, 511, 513 from the transceiver 112 according to the particular interval (T ms).

The method 1200 also includes transitioning a wake-up receiver into a receive mode to receive synchronization signals from a wake-up transmitter of the access point, at 1204. Each synchronization signal may be received within a particular time period of a last received synchronization signal and following a beacon transmission from the access point. The station may also include low-power protocol circuity operating according to a low-power protocol, and the wake-up receiver may be included in the low-power protocol circuitry. For example, referring to FIGS. 1 and 5, the wake-up receiver 136 may transition into the receive mode at slot 502 in response to the transceiver 132 receiving the Wi-Fi beacon 501. The wake-up receiver 136 may transition into the other receive modes at slots 504, 506, 508, 510, 512, 514 in response to the transceiver 132 receiving the Wi-Fi beacons 503, 505, 507, 509, 511, 513, respectively. Because the wake-up transmitter 116 transmits the synchronization signals 552, 554, 556 within the particular time period of a last transmitted synchronization signal, the wake-up receiver 136 may receive the synchronization signals 552, 554, 556 within the particular time period of a last received synchronization signal. For example, the wake-up receiver 136 may receive the synchronization signal 554 within the particular time period (e.g., within N×T ms) of receiving the synchronization signal 552.

The method 1200 also includes synchronizing a clock of the wake-up receiver to a clock of the wake-up transmitter based on at least one of the synchronization signals, at 1206. For example, referring to FIGS. 1 and 5, the low-power processor 134 may synchronize the clock 138 of the wake-up receiver 136 with the clock 118 of the wake-up transmitter 116 based on at least one of the synchronization signals 452, 454, 456.

Referring to FIG. 13, another method 1300 of operating an access point in a wireless network is shown. The method 1300 may be performed by the access point 102 of FIG. 1.

The method 1300 includes transmitting, at a transmitter of an access point in a wireless network, beacons to a receiver of a station in the wireless network according to a particular interval, at 1302. The access point may include primary protocol circuitry operating according to a first protocol, and the transmitter may be included in the primary protocol circuitry. For example, referring to FIGS. 1 and 5, the transceiver 112 may transmit beacons (e.g., Wi-Fi beacons 501, 503, 507, 509, 511, 513) to the transceiver 132 according a particular interval. For example, transceiver 112 may transmit a beacon to the transceiver 132 every T ms via the primary channel 140.

The method 1300 also includes determining, at a wake-up transmitter, a second particular interval of a receive mode schedule of a wake-up receiver of the station, at 1304. The second particular interval maybe based on the particular interval. The access point may also include low-power protocol circuitry operating according to a low-power protocol, and the wake-up transmitter may be included in the low-power protocol circuitry. For example, referring to FIGS. 1 and 5, the access point 102 may determine the second particular interval that the wake-up receiver 136 transitions into the receive mode. The wake-up transmitter 116 may access the medium access schedule 115 to determine the time intervals that the wake-up receiver 136 “listens in” on the low-power channel 150. The second particular interval may be based on the particular interval (T ms). For example, the second particular interval may be approximately equal to the particular interval (T ms) because the wake-up receiver 136 transitions into the receive mode after the access point 102 (e.g., the transceiver 112) sends the Wi-Fi beacons 501, 503, 505, 507, 509, 511, 513 according to the particular interval.

The method 1300 also includes transmitting, at the wake-up transmitter, synchronization signals to the wake-up receiver according to the second particular interval, at 1306. Each synchronization signal may be transmitted within a particular time period of a last transmitted synchronization signal and following transmission of a beacon. For example, referring to FIGS. 1 and 5, the access point 102 may transmit synchronization signals 552, 554, 556 to the wake-up receiver 136 according to the second particular intervals. To illustrate, the wake-up transmitter 116 may transmit the synchronization signal 552 when the wake-up receiver 136 is in the receive mode at slot 502, transmit the synchronization signal 554 when the wake-up receiver 136 is in the receive mode at slot 506, and transmit the synchronization signal 556 when the wake-up receiver 136 is in the receive mode 512. Each synchronization signal 552, 554, 556 may be transmitted within a particular time period (e.g., within N×T ms) of a last transmitted synchronization signal. For example, the synchronization signal 554 may be transmitted less than N×T ms from the synchronization signal 552, and the synchronization signal 556 may be transmitted N×T ms from the synchronization signal 556. According to one implementation, the wake-up transmitter 116 may determine particular slots to transmit the synchronization signals 552, 554, 556 based on the slot-skipping transmit schedule 117.

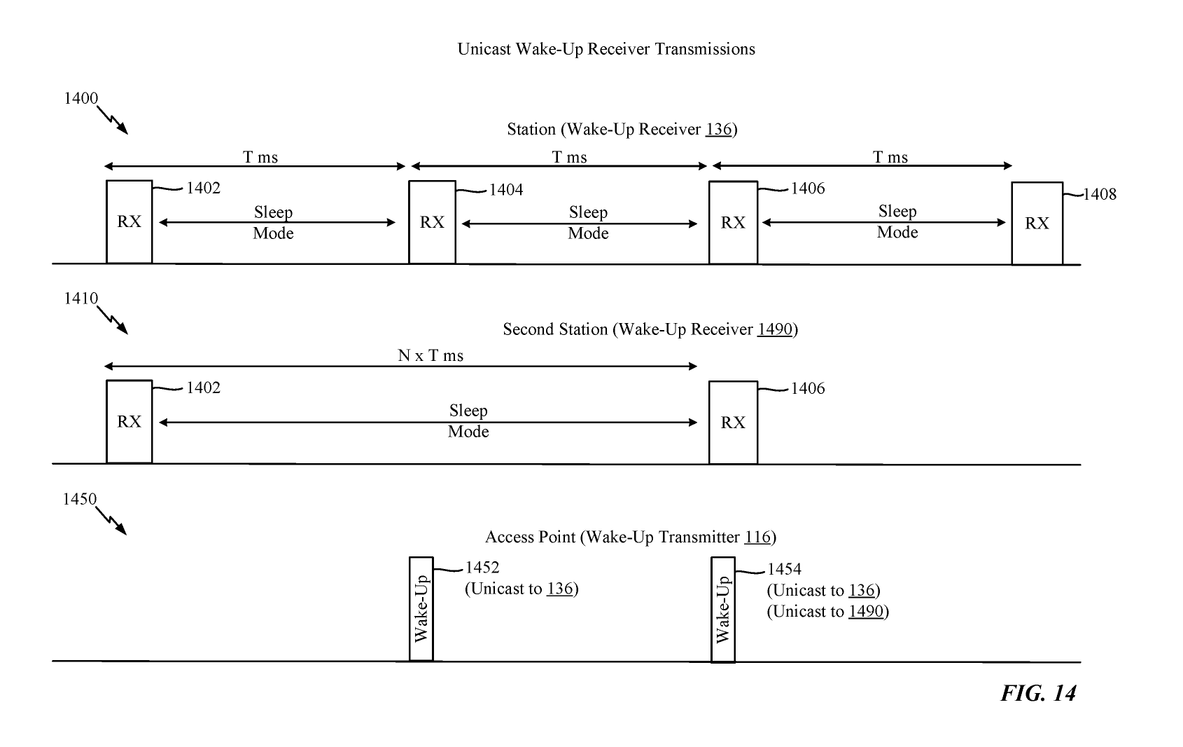

Referring to FIG. 14, a timing diagram 1400 of the wake-up receiver 136, a timing diagram 1410 of a wake-up receiver 1490 associated with a second station, and a timing diagram 1450 of the wake-up transmitter 116 is shown.

According to the timing diagram 1400, the wake-up receiver 136 may be configured to periodically transition into a receive mode (e.g., a “service period”) according to a first particular interval. In other implementations, the wake-up receiver 136 may continuously operate in the receive mode and the first particular interval may be determined by a periodicity of the service periods indicated by the access point 102. Additionally, the access point 102 may establish timing parameters for the service periods as an offset to a reference point in time, such as an offset to the timing synchronization function (TSF) of the access point 102. The periodicity of the service periods may be determined based on latency and energy consumption, and the periodicity of the service periods may be sent (with the offset) to the station 122 via the primary channel 140. The station 122 may determine to transit into the receive mode during each service period or during a subset of the service periods.

According to the timing diagram 1400, the first particular interval may be equal to T ms. As a non-limiting example, T may be equal to 100. Thus, the wake-up receiver 136 may periodically transition into the receive mode every 100 ms, which would lead to a “worst” case latency of 100 ms for receiving a wake-up message (e.g., the wake-up message 152 of FIG. 1). According to the timing diagram 1400, the wake-up receiver 136 may transition between the receive mode (RX) during time slots 1402, 1404, 1406, 1408 and sleep mode every T ms. Thus, during the time slots 1402, 1404, 1406, 1408 (e.g., the service periods), the wake-up receiver 136 may monitor the low-power channel 150 for wake-up messages and synchronization signals. According to one implementation, the station 122 associated with the wake-up receiver 136 may notify the access point 102 of the service periods based on an interval (e.g., T ms) and an offset based on a reference point. As a non-limiting example, the station 122 may send the medium access schedule 135 to the access point 102 via the primary channel 140, wherein the offset value is defined based on the timing synchronization function (TSF) of the access point 102 to notify the access point 102 of the service periods.

According to the timing diagram 1410, the wake-up receiver 1490 may be configured to periodically transition into the receive mode according to a second particular interval. The second particular interval may be equal to N×T ms. For example, if N is equal to 2 and T is equal to 100, the wake-up receiver 1490 may periodically transition into the receive mode every 200 ms. According to the timing diagram 1410, the wake-up receiver 1490 may transition between the receive mode during time slots 1402, 1406 and sleep mode every N×T ms. Thus, during the time slots 1402, 1406 (e.g., the service periods), the wake-up receiver 1490 may monitor the low-power channel 150 for wake-up messages and synchronization signals. According to one implementation, the second station associated with the wake-up receiver 1490 may notify the access point 102 of the service periods based on an interval (e.g., N×T ms) and an offset based on a reference point. As a non-limiting example, the second station may send a medium access schedule to the access point 102. According to another implementation, the second station may notify the access point 102 of the service periods based on an offset of the TSF of the access point 102.

According to the timing diagram 1450, the wake-up transmitter 116 may be configured to schedule wake-up receiver transmissions to the wake-up receivers 136, 1490 based on the service periods of the wake-up receivers 136, 1490. For example, the wake-up transmitter 116 may schedule a unicast wake-up receiver transmission to the wake-up receiver 136 during the time slot 1404 and during the time slot 1406. To illustrate, the wake-up transmitter 116 may send a wake-up message 1452 to the wake-up receiver 136 via the low-power channel 150 during the time slot 1404, and the wake-up transmitter 116 may also send a wake-up message 1454 to the wake-up receiver 136 via the low-power channel 150 during the time slot 1406. The wake-up transmitter 116 may also schedule a unicast wake-up receiver transmission to the wake-up receiver 1490 during the time slot 1406. To illustrate, the wake-up transmitter 116 may unicast the wake-up message 1454 to the wake-up receiver 1490 via the low-power channel 150 during the time slot 1406. Although wake-up messages 1452, 1454 are illustrated in FIG. 14, in other examples, configuration messages, synchronization messages, or command messages may be transmitted.

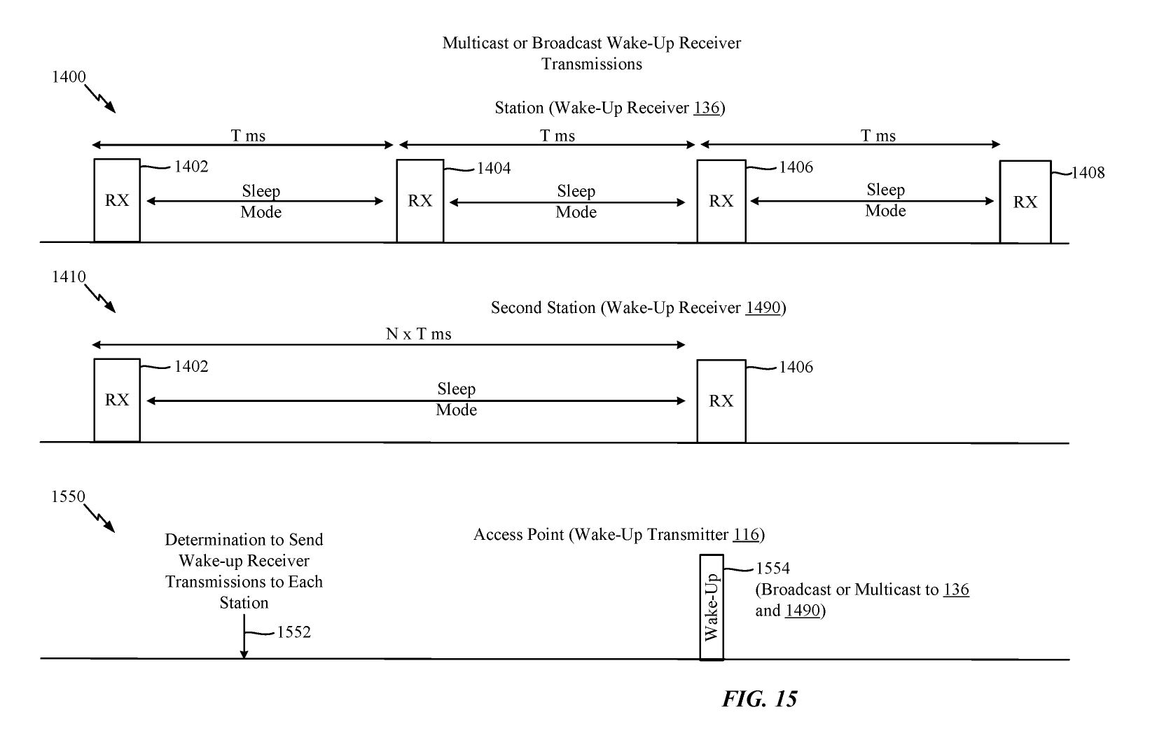

Referring to FIG. 15, the timing diagram 1400 of the wake-up receiver 136, the timing diagram 1410 of the wake-up receiver 1490 associated with the second station, and a timing diagram 1550 of the wake-up transmitter 116 is shown.

According to the timing diagram 1550, the access point 102 may determine to send wake-up receiver transmissions to each station (e.g., the station 122 and the second station associated with the wake-up receiver 1490) at a time slot 1552. For example, in between the time slot 1402 and the time slot 140, the access point 102 may determine to send wake-up messages to each wake-up receiver 136, 1490 via the low-power channel 150. The access point 102 may determine a particular time slot that each wake-up receiver 136, 1490 is in the receive mode (e.g., the “service period”) and broadcast (or multicast) a wake-up message to each wake-up receiver 136, 1490 during the particular time slot.

To illustrate, the access point 102 may determine that each wake-up receiver 136, 1490 is in the receive mode during the time slot 1406. As a result, the wake-up transmitter 116 may transmit (e.g., broadcast or multicast) a wake-up message 1554 to the wake-up receiver 136, 1490 via the low-power channel 150 during the time slot 106. Thus, according to the implementation illustrated in FIG. 15, the wake-up transmitter 116 may initiate wake-up receiver transmissions during the time slot 1406 that each target station is in the receive mode (e.g., the service period).

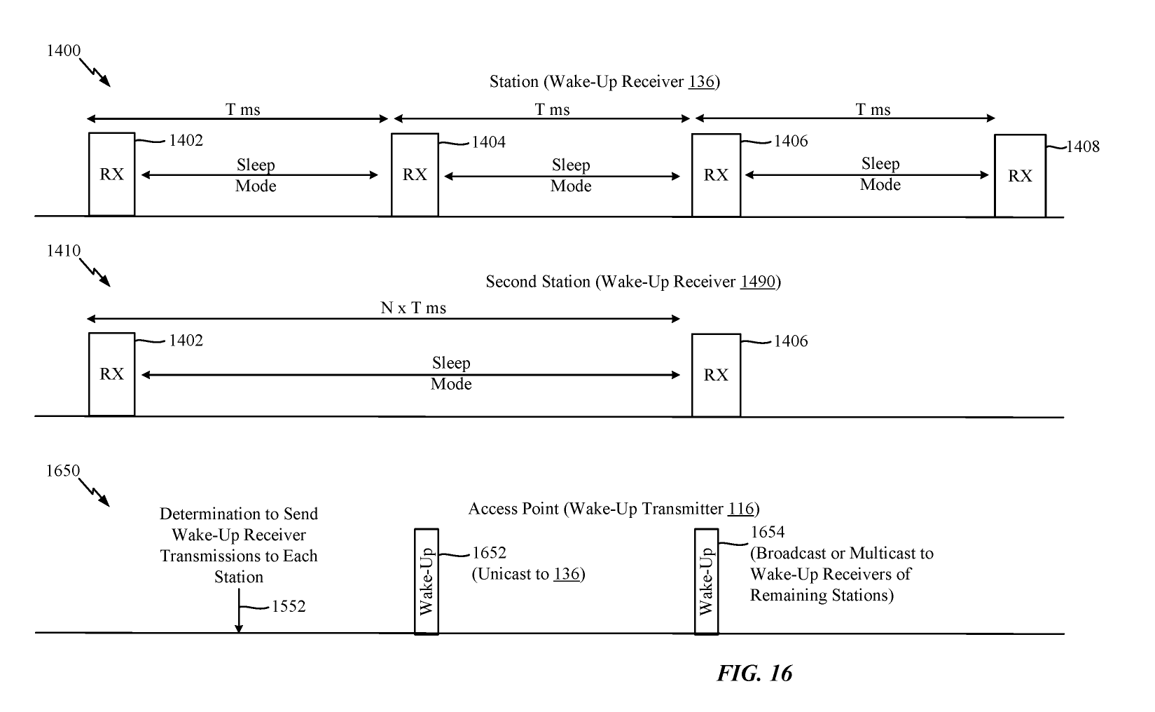

Referring to FIG. 16, the timing diagram 1400 of the wake-up receiver 136, the timing diagram 1410 of the wake-up receiver 1490 associated with the second station, and a timing diagram 1650 of the wake-up transmitter 116 is shown.

According to the implementation illustrated in FIG. 16, after the determination to send wake-up receiver transmissions to each station, the access point 116 may unicast wake-up messages to stations (e.g., wake-up receivers) having service periods earlier in time than other stations. For example, because the wake-up receiver 136 has a service period during the time slot 1404 and the wake-up receiver 1490 fails to have a service period until the time slot 1406, the wake-up transmitter 116 may unicast a wake-up message 1652 to the wake-up receiver 136 via the low-power channel 150 during the time slot 1404. The wake-up transmitter 116 may send (e.g., multicast or unicast) one or more wake-up messages 1654 to the remaining wake-up receivers (e.g., the wake-up receiver 1490) during the time slot 1406.

The techniques described with respect to FIGS. 14-16 enable power and energy savings for stations having relaxed latency parameters. For example, wake-up receivers of stations having relaxed latency parameters may remain in the sleep mode for extended periods of time compared to wake-up receivers having stringent latency parameters. According to the techniques described with respect to FIGS. 14-16, each station may determine a wake-up receiver service period interval (e.g., intervals where the wake-up receivers are in the receive mode). The intervals may be derived based on power parameters, latency parameters, medium conditions, etc. The intervals may also be fixed or variable based on a pseudo-random sequence. Each station may announce (e.g., send) the service period interval to the access point. Additionally, or in the alternative, each station may announce a range of acceptable wake-up receiver service periods.

For unicast wake-up receiver transmissions, the access point 102 may transmit wake-up messages to particular stations during service periods that the particular stations monitor. According to one implementation, if a station continuously monitors the low-power channel 150, the access point 102 may initiate wake-up receiver transmissions at any instance independent of the service periods.

For multicast or broadcast wake-up receiver transmissions, the access point 102 may initiate wake-up receiver transmission during a service period that each target station monitors, as described with respect to FIG. 15. Alternatively, the access point 102 may unicast wake-up receiver transmissions to particular stations and multicast wake-up receiver transmissions to other stations, as described with respect to FIG. 16. The access point 102 may indicate transmission scheme capabilities based on the multicast/broadcast wake-up receiver transmissions.

The stations (e.g., the wake-up receivers 136, 1490) may continuously monitor wake-up receiver transmissions, monitor each wake-up receiver transmission service period (e.g., enter into the receive mode during each interval 1402, 1404, 1406, 1408), or monitor a subset of the wake-up receiver transmission service periods. The stations may determine monitoring schemes based on power and latency parameters. The stations may notify the access point 102 of the monitoring scheme using the medium access schedule 135, and the stations may indicate “preferred” service period intervals to the access point 102.

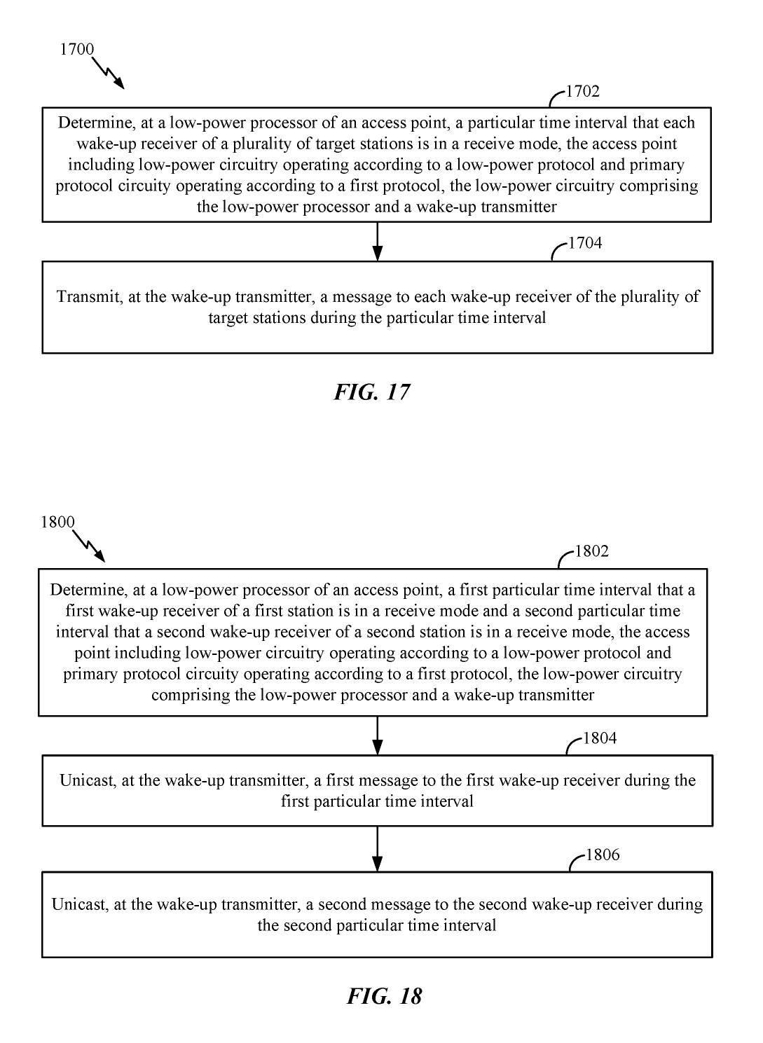

Referring to FIG. 17, another method 1700 of operating an access point in a wireless network is shown. The method 1700 may be performed by the access point 102 of FIG. 1.

The method 1700 includes determining, at a low-power processor of an access point, a particular time interval that each wake-up receiver of a plurality of target stations is in a receive mode, at 1702. The access point may include low-power circuitry operating according to a low-power protocol and primary protocol circuity operating according to a first protocol. The low-power circuitry may include the low-power processor and a wake-up transmitter. For example, referring to FIGS. 1 and 15, the access point 102 may determine that the wake-up receivers 136, 1490 are in the receive mode during the time slot 1406.

The method 1700 also includes transmitting, at the wake-up transmitter, a message to each wake-up receiver of the plurality of target stations during the particular time interval, at 1704. For example, referring to FIGS. 1 and 15, the wake-up transmitter 116 may transmit (e.g., broadcast or multicast) the wake-up message 1554 to the wake-up receivers 136, 1490 during the time slot 1406. According to other implementations, the message may include a wake-up message, a configuration message, a synchronization message, or a command message.

Referring to FIG. 18, another method 1800 of operating an access point in a wireless network is shown. The method 1800 may be performed by the access point 102 of FIG. 1.

The method 1800 includes determining, at a low-power processor of an access point, a first particular time interval that a first wake-up receiver of a first station is in a receive mode and a second particular time interval that a second wake-up receiver of a second station is in a receive mode, at 1802. The access point may include low-power circuitry operating according to a low-power protocol and primary protocol circuity operating according to a first protocol. The low-power circuitry may include the low-power processor and a wake-up transmitter. For example, referring to FIGS. 1 and 14, the access point 102 may determine that the wake-up receiver 136 is in the receive mode at time slots 1404, 1406 and that the wake-up receiver 1490 is in the receive mode at time slot 1406.

The method 1800 also includes unicasting, at the wake-up transmitter, a first message to the first wake-up receiver during the first particular time interval, at 1804. For example, referring to FIGS. 1 and 14, the wake-up transmitter 116 may unicast the wake-up message 1452 to the wakeup-receiver 136 during the time slot 1404.

The method 1800 also includes unicasting, at the wake-up transmitter, a second message to the second wake-up receiver during the second particular time interval, at 1806. For example, referring to FIGS. 1 and 14, the wake-up transmitter 116 may unicast the wake-up message 1454 to the wakeup-receiver 1490 during the time slot 1406.

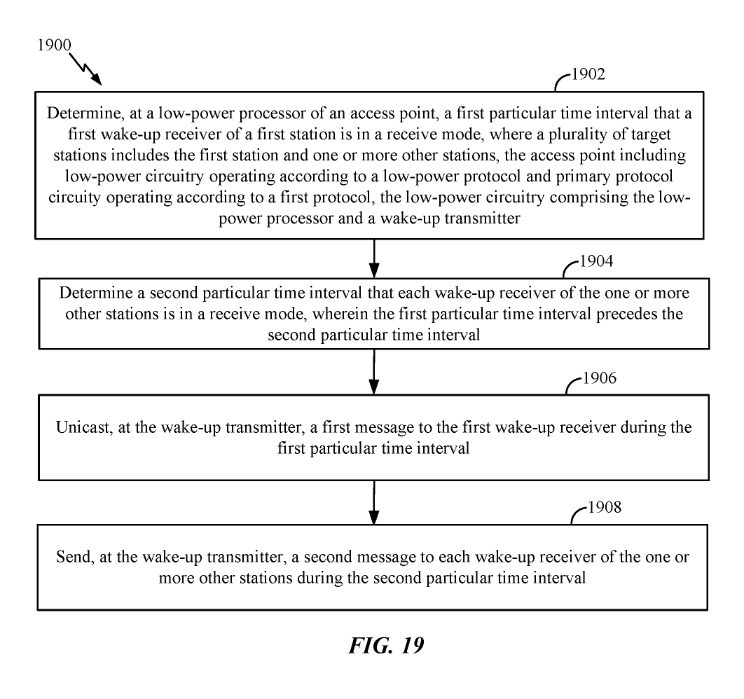

Referring to FIG. 19, another method 1900 of operating an access point in a wireless network is shown. The method 1900 may be performed by the access point 102 of FIG. 1.

The method 1900 includes determining, at a low-power processor of an access point, a first particular time interval that a first wake-up receiver of a first station is in a receive mode, at 1902. A plurality of target stations may include the first station and one or more other stations. The access point may include low-power circuitry operating according to a low-power protocol and primary protocol circuity operating according to a first protocol. The low-power circuitry may include the low-power processor and a wake-up transmitter. For example, referring to FIGS. 1 and 16, the access point 102 may determine that the wake-up receiver 136 is in the receive mode during the time slots 1404, 1406, 1408.

The method 1900 may also include determining a second particular time interval that each wake-up receiver of the one or more other stations is in a receive mode, at 1904. The first particular time interval may precede the second particular time interval. For example, referring to FIGS. 1 and 16, the access point 102 may determine that the wake-up receiver 1490 is in the receive mode during the time slot 1406.

The method 1900 may also include unicasting, at the wake-up transmitter, a first message to the first wake-up receiver during the first particular time interval, at 1906. For example, referring to FIGS. 1 and 16, the wake-up transmitter 116 may unicast the wake-up message 1652 to the wake-up receiver 136 during the time slots 1404, 1408.

The method 1900 also includes sending, at the wake-up transmitter, a second message to each wake-up receiver of the one or more other stations during the second particular time interval, at 1908. For example, referring to FIGS. 1 and 16, the wake-up transmitter 116 may send (e.g., broadcast or multicast) the wake-up message 1654 to the wake-up receivers 136, 1490 during the time slot 1406.

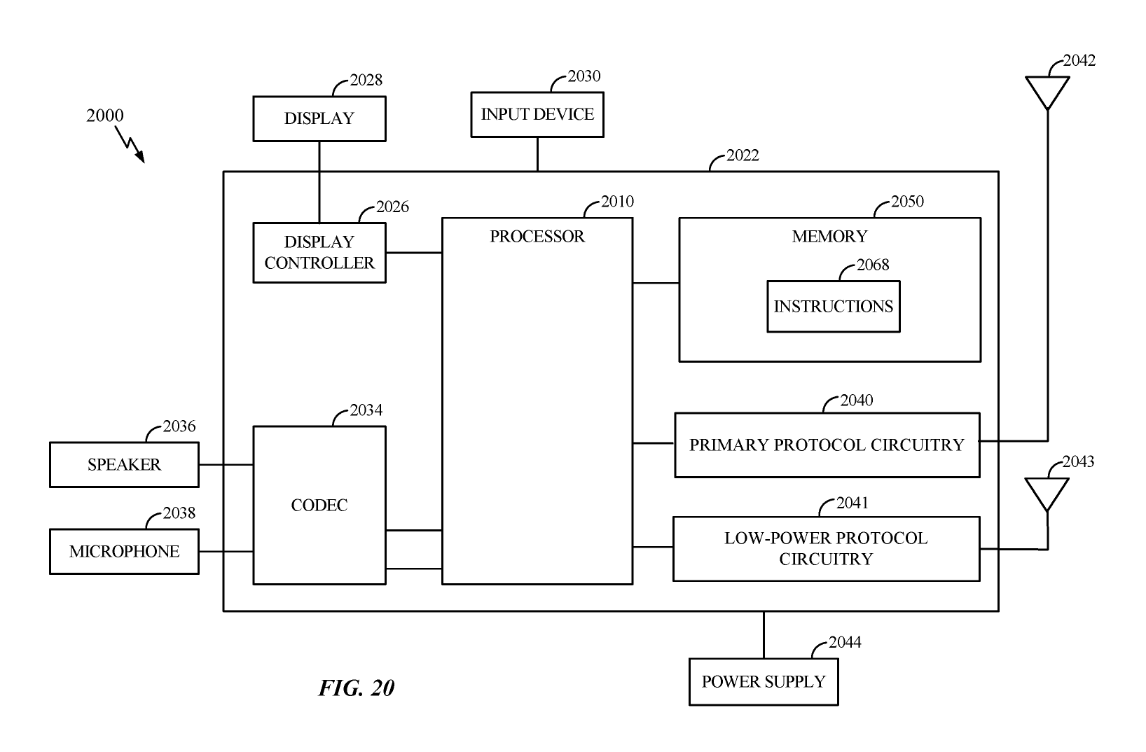

Referring to FIG. 20, a block diagram of a device 2000 is shown. According one implementation, the device 2000 may correspond to the access point 102 of FIG. 1. According to another implementation, the device 2000 may corresponds to the station 122 of FIG. 1. The device 2000 includes a processor 2010, such as a digital signal processor, coupled to a memory 2050. Primary protocol circuitry 2040 is coupled to the processor 2010, and low-power protocol circuitry 2041 is coupled to the processor 2010.

The processor 2010 may be configured to execute software (e.g., a program of one or more instructions 2068) stored in the memory 2050. Additionally or alternatively, the processor 2010 may be configured to implement one or more instructions stored in a memory of the primary protocol circuitry 2040 and/or to implement one or more instructions stored in a memory of the low-power protocol circuitry 2041. If the device 2000 corresponds to the access point 102, the primary protocol circuitry 2040 may correspond to the primary protocol circuitry 106 of FIG. 1 and the low-power protocol circuitry 2041 may correspond to the low-power protocol circuitry 108 of FIG. 1. If the device 2000 corresponds to the station 122, the primary protocol circuitry 2040 may correspond to the primary protocol circuitry 126 of FIG. 1 and the low-power protocol circuitry 2041 may correspond to the low-power protocol circuitry 128 of FIG. 1. The processor 2010, the primary protocol circuitry 2040, and the low-power protocol circuitry 2041 may be configured to operate in accordance with the methods 600-1300 of FIGS. 6-13 and the methods 1700-1900 of FIGS. 17-19. The primary protocol circuitry 2040 may be coupled to an antenna 2042 such that wireless data received via the antenna 2042 may be provided to the processor 2010. The low-power protocol circuitry 2041 may be coupled to an antenna 2043 such that wireless data received via the antenna 2043 may be provided to the processor 2010.

A coder/decoder (CODEC) 2034 can also be coupled to the processor 2010. A speaker 2036 and a microphone 2038 can be coupled to the CODEC 2034. A display controller 2026 can be coupled to the processor 2019 and to a display device 2028. In a particular implementation, the processor 2010, the display controller 2026, the memory 2050, the CODEC 2034, the primary protocol circuitry 2040, and the low-power protocol circuitry 2041 are included in a system-in-package or system-on-chip device 2022. In a particular implementation, an input device 2030 and a power supply 2044 are coupled to the system-on-chip device 2022. Moreover, in a particular implementation, as illustrated in FIG. 20, the display device 2028, the input device 2030, the speaker 2036, the microphone 2038, the antenna 2042, the antenna 2043, and the power supply 2044 are external to the system-on-chip device 2022. However, each of the display device 2028, the input device 2030, the speaker 2036, the microphone 2038, the antenna 2042, the antenna 2043, and the power supply 2044 can be coupled to one or more components of the system-on-chip device 2022, such as one or more interfaces or controllers.

In conjunction with the described implementations, an apparatus includes means for operating according to a low-power protocol. For example, the means for operating according to the low-power protocol may include the low-power protocol circuitry 108 of FIG. 1, the low-power protocol circuitry 128 of FIG. 1, the low-power protocol circuitry 2041 of FIG. 20, a processor programmed to execute instructions, one or more other devices, circuits, modules, instructions, or any combination thereof.

The apparatus may also include means for operating according to a first protocol coupled to the means for operating to the low-power protocol. For example, the means for operating according to the first protocol may include the primary protocol circuitry 106 of FIG. 1, the primary protocol circuitry 126 of FIG. 1, the primary protocol circuitry 2040 of FIG. 20, a processor programmed to execute instructions, one or more other devices, circuits, modules, instructions, or any combination thereof.

Those of skill in the art would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient (e.g., non-transitory) storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims.

What is claimed is:

1. A station configured to operate in a wireless network, the station comprising:
low-power protocol circuitry configured to operate according to a low-power protocol, the low-power protocol circuity comprising:
a wake-up receiver configured to:
periodically transition into a receive mode according to a particular interval; and
receive synchronization signals from a wake-up transmitter of an access point in the wireless network, each synchronization signal received at a particular integer multiple of the particular interval; and
a low-power processor configured to synchronize a clock of the wake-up receiver to a clock of the wake-up transmitter based on at least one of the synchronization signals; and
primary protocol circuitry configured to operate according to a first protocol, the primary protocol circuitry coupled to the low-power protocol circuitry.

2. The station of claim 1, wherein the particular integer multiple is greater than one.

3. The station of claim 1, wherein the wake-up receiver is configured to receive the synchronization signals via a low-power channel according to the low-power protocol, and wherein the first protocol comprises an Institute of Electrical and Electronics Engineers (IEEE) 802.11 protocol.

4. The station of claim 1, wherein the wake-up receiver is further configured to receive a wake-up message from the wake-up transmitter when the wake-up receiver is in the receive mode.

5. The station of claim 4, wherein the low-power processor is further configured to generate an activation signal to transition the primary protocol circuitry into an awake mode in response to receiving the wake-up message.

6. The station of claim 1, wherein the wake-up receiver comprises a counter configured to:
load a fixed value; and
transition the wake-up receiver into the receive mode in response to counting to zero from the fixed value.

7. The station of claim 1, wherein each synchronization signal is received within a particular time period after a last received synchronization signal.

8. The station of claim 1, wherein each synchronization signal is received within a particular time period after a last received synchronization signal and following a beacon transmission from the access point.

9. A method of operating a station in a wireless network, the method comprising:
periodically transitioning a wake-up receiver into a receive mode according to a particular interval, the station including primary protocol circuitry operating according to a first protocol and low-power protocol circuitry operating according to a low-power protocol, the wake-up receiver included in the low-power protocol circuitry;
receiving, at the wake-up receiver, synchronization signals from a wake-up transmitter of an access point in the wireless network, each synchronization signal received at a particular integer multiple of the particular interval; and
synchronizing a clock of the wake-up receiver to a clock of the wake-up transmitter based on at least one of the synchronization signals.

10. The method of claim 9, wherein the particular integer multiple is greater than one.

11. The method of claim 9, wherein the synchronization signals are received via a low-power channel according to the low-power protocol.

12. The method of claim 9, further comprising receiving, at the wake-up receiver, a wake-up message from the wake-up transmitter when the wake-up receiver is in the receive mode.

13. The method of claim 12, further comprising generating, at the wake-up receiver, an activation signal, at a low-power processor of the low-power protocol circuity, to transition the primary protocol circuitry of the station into an awake mode in response to receiving the wake-up message.

14. The method of claim 9, wherein periodically transitioning the wake-up receiver into the receive mode comprises:
loading a counter of the wake-up receiver with a fixed value; and
transitioning the wake-up receiver into the receive mode in response to counting to zero from the fixed value.

15. The method of claim 9, wherein each synchronization signal is received within a particular time period after a last received synchronization signal.

16. The method of claim 9, wherein each synchronization signal is received within a particular time period after a last received synchronization signal and following a beacon transmission from the access point.

17. An access point configured to operate in a wireless network, the access point comprising:
low-power protocol circuitry configured to operate according to a low-power protocol, the low-power protocol circuity comprising:
a wake-up transmitter configured to:
determine a particular time interval that each wake-up receiver of a plurality of target stations is in a receive mode; and
transmit a message to each wake-up receiver of the plurality of target stations during the particular time interval; and
primary protocol circuitry configured to operate according to a first protocol, the primary protocol circuitry coupled to the low-power protocol circuitry.

18. The access point of claim 17, wherein the wake-up transmitter is configured to transmit the message via a low-power channel according to the low-power protocol.

19. The access point of claim 17, wherein the first protocol comprises an Institute of Electrical and Electronics Engineers (IEEE) 802.11 protocol.

20. The access point of claim 17, wherein the message comprises a wake-up message, a configuration message, a synchronization message, or a command message.

21. The access point of claim 17, wherein the particular time interval is determined based on a periodicity of service periods indicated by the access point.

22. The access point of claim 21, wherein the low-power protocol circuitry comprises a low-power processor configured to establish timing parameters for the service periods based on an offset to a timing synchronization function of the access point.

23. The access point of claim 21, wherein the periodicity of the service periods is determined based on latency and energy consumption, and wherein the wake-up transmitter transmits the timing parameters to each wake-up receiver.

24. The access point of claim 21, wherein one or more stations of the plurality of target stations transits into the receive mode during each service period.

25. The access point of claim 21, wherein one or more stations of the plurality of target stations transits into the receive mode during a subset of the service periods.

26. The access point of claim 17, wherein each wake-up receiver is configured to determine service periods associated with monitoring a low-power channel.

27. The access point of claim 26, wherein the service periods are determined based on an interval and an offset to a timing synchronization function of the access point.

28. A method of operating an access point in a wireless network, the method comprising:
determining, at a low-power processor, a particular time interval that each wake-up receiver of a plurality of target stations is in a receive mode, the access point including low-power circuitry operating according to a low-power protocol and primary protocol circuity operating according to a first protocol, the low-power circuitry comprising the low-power processor and a wake-up transmitter; and
transmitting, at the wake-up transmitter, a message to each wake-up receiver of the plurality of target stations during the particular time interval.

29. The method of claim 28, wherein the message is transmitted via a low-power channel according to the low-power protocol.

30. The method of claim 28, wherein the first protocol comprises an Institute of Electrical and Electronics Engineers (IEEE) 802.11 protocol.
